(19) United States
(12) Patent Application Publication
(10) Pub. No.: US 2024/0332867 A1
(43) Pub. Date: Oct. 3, 2024

(54) HIGH SPEED, HIGH DENSITY CONNECTOR

(71) Applicant: FCI USA LLC, Etters, PA (US)

(72) Inventors: Steven Anthony Blasko, III, New Cumberland, PA (US); Benjamin Reed Staudt, Harrisburg, PA (US); Mark E. Lauermann, Harrisburg, PA (US); Steven E. Minich, York, PA (US); Mark R. Gray, York, PA (US); William Tanis, Mechanicsburg, PA (US)

(73) Assignee: FCI USA LLC, Etters, PA (US)

(21) Appl. No.: 18/619,065

(22) Filed: Mar. 27, 2024

Related U.S. Application Data
(60) Provisional application No. 63/516,594, filed on Jul. 31, 2023.
(60) Provisional application No. 63/492,744, filed on Mar. 28, 2023.

(51) Int. Cl. H01R 13/6585; H01R 12/71; H01R 12/72; H01R 13/6471

(52) U.S. Cl. CPC H01R 13/6585; H01R 12/716; H01R 12/724; H01R 13/6471

(57) ABSTRACT

Electrical connectors for very high speed signals at frequencies to support high data rates, including at or above 112 Gbps. A connector includes lead assemblies, each of which includes conductors held by an assembly housing, and shielding members disposed on opposite sides of the assembly housing. Each conductor has a mating end and a mounting end opposite the mating end. The shielding members have tabs disposed on the mating ends of ground conductors from the opposite sides. The tabs on the opposite sides can be welded to respective ground conductors simultaneously. The tabs are connected to bodies of respective shielding members by beams separated by slots. The slots are sized to both provide tolerances for welding and to reduce crosstalk further. The shielding members alternatively or additionally can have tabs disposed on the mounting ends of the ground conductors from the opposite sides.

### CROSS-REFERENCE TO RELATED APPLICATIONS

This application claims priority to and the benefit under 35 U.S.C. § 119 (e) of U.S. Provisional Patent Application Ser. No. 63/516,594, filed on Jul. 31, 2023, entitled “HIGH SPEED, HIGH DENSITY CONNECTOR.” This application also claims priority to and the benefit under 35 U.S.C. § 119 (e) of U.S. Provisional Patent Application Ser. No. 63/492,744, filed on Mar. 28, 2023, entitled “HIGH SPEED, HIGH DENSITY CONNECTOR.” The contents of these applications are incorporated herein by reference in their entirety.

### TECHNICAL FIELD

This patent application relates generally to interconnection systems, such as those including electrical connectors, used to interconnect electronic assemblies.

### BACKGROUND

Electrical connectors are used in many electronic systems. It is generally easier and more cost effective to manufacture a system as separate electronic assemblies, such as printed circuit boards (“PCBs”), which may be joined together with electrical connectors. A known arrangement for joining several printed circuit boards is to have one printed circuit board serve as a backplane. Other printed circuit boards, called “daughterboards” or “daughtercards,” may be connected through the backplane.

A known backplane is a printed circuit board onto which many connectors may be mounted. Conducting traces in the backplane may be electrically connected to signal conductors in the connectors so that signals may be routed between the connectors. Daughtercards may also have connectors mounted thereon. The connectors mounted on a daughtercard may be plugged into the connectors mounted on the backplane. In this way, signals may be routed among the daughtercards through the backplane. The daughtercards may plug into the backplane at a right angle. The connectors used for these applications may therefore include a right angle bend and are often called “right angle connectors.”

In other system configurations, signals may be routed between parallel boards, one above the other. Connectors used in these applications are often called “stacking connectors” or “mezzanine connectors.” In yet other configurations, orthogonal boards may be aligned with edges facing each other. Connectors used in these applications are often called “direct mate orthogonal connectors.” In yet other system configurations, cables may be terminated to a connector, sometimes referred to as a cable connector. The cable connector may plug into a connector mounted to a printed circuit board such that signals that are routed through the system by the cables are connected to components on the printed circuit board.

Regardless of the exact application, electrical connector designs have been adapted to mirror trends in the electronics industry. Electronic systems generally have gotten smaller, faster, and functionally more complex. Because of these changes, the number of circuits in a given area of an electronic system, along with the frequencies at which the circuits operate, have increased significantly in recent years. Current systems pass more data between printed circuit boards and require electrical connectors that are electrically capable of handling more data at higher speeds than connectors of even a few years ago.

In a high density, high speed connector, electrical conductors may be so close to each other that there may be electrical interference between adjacent signal conductors. To reduce interference, and to otherwise provide desirable electrical properties, shield members are often placed between or around adjacent signal conductors. The shields may prevent signals carried on one conductor from creating “crosstalk” on another conductor. The shield may also impact the impedance of each conductor, which may further contribute to desirable electrical properties.

Other techniques may be used to control the performance of a connector. For instance, transmitting signals differentially may also reduce crosstalk. Differential signals are carried on a pair of conducting paths, called a “differential pair.” The voltage difference between the conductive paths represents the signal. In general, a differential pair is designed with preferential coupling between the conducting paths of the pair. For example, the two conducting paths of a differential pair may be arranged to run closer to each other than to adjacent signal paths in the connector. No shielding is desired between the conducting paths of the pair, but shielding may be used between differential pairs. Electrical connectors can be designed for differential signals as well as for single-ended signals.

In an interconnection system, connectors are attached to printed circuit boards. Typically, a printed circuit board is formed as a multi-layer assembly manufactured from stacks of dielectric sheets, sometimes called “prepreg.” Some or all of the dielectric sheets may have a conductive film on one or both surfaces. Some of the conductive films may be patterned, using lithographic or laser printing techniques, to form conductive traces that are used to make interconnections between components mounted to the printed circuit board. Others of the conductive films may be left substantially intact and may act as ground planes or power planes that supply the reference potentials. The dielectric sheets may be formed into an integral board structure by heating and pressing the stacked dielectric sheets together.

To make electrical connections to the conductive traces or ground/power planes, holes may be drilled through the printed circuit board. These holes, or “vias”, are filled or plated with metal such that a via is electrically connected to one or more of the conductive traces or planes through which it passes.

To attach connectors to the printed circuit board, contact “tails” from the connectors may be inserted into the vias or attached to conductive pads on a surface of the printed circuit board that are connected to a via.

### BRIEF SUMMARY

Embodiments of a high speed, high density interconnection system are described.

Some embodiments relate to a lead assembly for an electrical connector. The lead assembly may include an assembly housing; a plurality of conductive elements held by the assembly housing, each of the plurality of conductive elements comprising a mating end extending out of the assembly housing, a mounting end opposite the mating end and extending out of the assembly housing, and an intermediate portion joining the mating end and the mounting end, the plurality of conductive elements comprising ground conductors disposed between signal conductors; and a shielding member comprising a body, a plurality of tabs disposed on the mating ends of respective ground conductors of the plurality of conductive elements, and a plurality of transition portions connecting the plurality of tabs to the body.

Optionally, tabs of the plurality of tabs of the shielding member may be welded to respective ground conductors of the plurality of conductive elements.

Optionally, the mounting ends of the plurality of signal conductors may be configured for attachment of conductors of respective cables.

Optionally, the body of the shielding member may comprise a plurality of beams; and each of the plurality of beams may be connected to a respective tab of the plurality of tabs through a transition portion of the plurality of transition portions.

Optionally, the body of the shielding member may comprise a plurality of slots separating the plurality of beams from each other or an adjacent portion of the body.

Optionally, each of the plurality of tabs may be connected to the body of the shielding member by two transition portions disposed at opposite ends of the tab.

Optionally, each of the two transition portions may be connected to a respective beam of the body of the shielding member; and the respective beams may be separated by a slot.

Optionally, the assembly housing may comprise a first side, a second side opposite the first side, and a mating edge joining the first side and second side; each of the ground conductors may comprise an opening extending therethrough; and for each of the ground conductors, a respective tab of the plurality of tabs of the shielding member may be disposed between the mating edge of the assembly housing and the opening of the ground conductor.

Optionally, the mating edge of the assembly may comprise a plurality of recesses; and the plurality of transition portions of the shielding member may be disposed in respective recesses of the plurality of recesses.

Optionally, the plurality of tabs may be at least partially disposed in respective recesses of the plurality of recesses.

Optionally, the shielding member may be a first shielding member disposed on a first side of the lead assembly; and the lead assembly may comprise a second shielding member comprising a second body disposed on a second side of the lead assembly opposite the first side of the lead assembly, a second plurality of tabs disposed on the mating ends of respective ground conductors of the plurality of conductive elements, and a second plurality of transition portions connecting the second plurality of tabs to the second body.

Optionally, tabs of the second plurality of tabs may be welded to respective ground conductors of the plurality of conductive elements.

Optionally, each of the ground conductors has tabs of the first and second shielding members disposed on opposite sides and overlapping with each other.

Some embodiments relate to a lead assembly for an electrical connector. The lead assembly may comprise an assembly housing comprising a first side, and a second side opposite the first side; a plurality of conductive elements held by the assembly housing, each of the plurality of conductive elements comprising a mating end extending out of the assembly housing, a mounting end opposite the mating end and extending out of the assembly housing, and an intermediate portion joining the mating end and the mounting end, the plurality of conductive elements comprising first type conductors disposed between second type conductors, wherein the first type conductors may be wider than the second type conductors; a first shielding member disposed on the first side of the lead assembly and comprising a plurality of first tabs electrically and mechanically connected to the mating ends of respective first-type conductors of the plurality of conductive elements from the first side of the assembly; and a second shielding member comprising a plurality of second tabs electrically and mechanically connected to the mating ends of respective first-type conductors of the plurality of conductive elements from the second side of the assembly.

Optionally, the lead assembly may further comprise lossy material coupling the first shield member to the second shielding member.

Optionally, the lead assembly may further comprise lossy material coupling the first shield member to first-type conductors of the plurality of conductive elements and coupling the second shielding member to first-type conductors of the plurality of conductive elements.

Optionally, the mounting ends of the plurality of conductive elements may extend from the connector at a mounting interface; and each of the first and second shielding members may comprise a shielding interconnect configured for connection to a ground structure of a printed circuit board at the mounting interface.

Optionally, for each of the second type conductors, a portion of the mating end may be sandwiched between a first tab and a second tab.

Optionally, the plurality of first tabs and the plurality of second tabs may be symmetrically disposed about a column that the mating ends of the plurality of conductive elements may be aligned in.

Optionally, the plurality of first tabs and the plurality of second tabs may be disposed in pairs; each pair may have a first tab and a second tab; and the first tab and second tab in each pair may overlap with each other.

Optionally, the first shielding member may comprise a first body disposed on the first side of the lead assembly and a plurality of beams connected to the plurality of first tabs; and the second shielding member may comprise a second body disposed on the second side of the lead assembly and a plurality of beams connected to the plurality of second tabs.

Optionally, the second shielding member may comprise a plurality of third tabs disposed between the plurality of first tabs and separated from the mating ends of respective signal conductors of the plurality of conductive elements.

Some embodiments relate to an electrical connector. The electrical connector may comprise a housing comprising a plurality of walls extending in parallel and bounding a mating interface region; and a plurality of lead assemblies disposed between the plurality of walls, each of the plurality of lead assemblies comprising: a column of conductive elements, each comprising a mating end, a mounting end opposite the mating end, and an intermediate portion joining the mating end and the mounting end, and a shielding member comprising a body extending in a plane parallel to the intermediate portions of the conductive elements of the column, wherein, for each of the plurality of lead assemblies: the shielding member may comprise a plurality of tabs connected to selected ones of the column of conductive elements, and a plurality of beams connected to respective tabs of the plurality of tabs; and each of the plurality of beams extending into the mating interface region bounded by the plurality of walls.

Optionally, for each of the plurality of lead assemblies: the shielding member may comprise a plurality of transition portions joining respective beams and tabs; and the plurality of transition portions may extend in a direction perpendicular to the plurality of beams and the column of conductive elements.

Optionally, for each of the plurality of lead assemblies: for each tab, the beams connected to the tab may be separated from each other by slots extending at least to the respective inner wall.

Optionally, the electrical connector may further comprise a plurality of core members, each of the plurality of core members comprising a body and a mating portion extending from the body, the body and the mating portion comprising insulative material, the mating portion further comprising an interface shield, wherein: for each of the plurality of core members, at least one of the plurality of lead assemblies may be attached to the core member; and for each of the plurality of lead assemblies, the slots may at least partially overlap the interface shield of the respective core member.

Optionally, the electrical connector may further comprise a plurality of core members, each of the plurality of core members comprising a body and a mating portion extending from the body, the body and the mating portion comprising insulative material, the mating portion further comprising an interface shield, wherein: for each of the plurality of core members, at least one of the plurality of lead assemblies may be attached to the core member and the shielding members of the at least one of the plurality of lead assemblies may be electrically connected to the interface shield. Some embodiments relate to a shielding member for an electrical connector.

The shielding member may comprise a plate comprising a mating side and a mounting side opposite the mating side; a plurality of first tabs connected to the mating side of the plate and aligned in a first line; and a plurality of second tabs connected to the mounting side of the plate and aligned in a second line parallel to the first line.

Optionally, the plate may extend in a first plane; and the plurality of first tabs and the plurality of second tabs may extend in a second plane that is parallel to and offset from the first plane.

Optionally, the plate may comprise a plurality of openings aligned in a third line parallel to the first line.

Optionally, each of the plurality of first tabs may be connected to the mating side of the plate via a plurality of compliant beams.

Optionally, the shielding member may comprise a plurality of first transition portions, wherein each of the plurality of first tabs may be connected to the mating side of the plate by two of the plurality of first transition portions.

Optionally, the shielding member may comprise a plurality of second transition portions, wherein each of the plurality of second tabs may be connected to the mounting side of the plate by a single one of the plurality of second transition portions.

Optionally, the mounting side of the plate may comprise an opening; and one of the plurality of second transition portions may join the opening of the mounting side of the plate and a second tab at an end of the second line.

Optionally, the plate may comprise a side connecting the mating side and the mounting side; the shielding member may comprise a third tab extending from the side connecting the mating side and the mounting side; and the third tab may extend in a direction perpendicular to the first plane.

Optionally, the third tab may comprise a bulge or an opening configured to receive a bulge.

Some embodiments relate to a lead assembly for an electrical connector. The lead assembly may comprise a housing; a plurality of conductive elements held in a column by the housing, each of the plurality of conductive elements comprising a mating end, a mounting end opposite the mating end, and an intermediate portion extending between the mating end and the mounting end, the plurality of conductive elements comprising ground conductors disposed between signal conductors; and a shielding member comprising a body disposed on the housing, a plurality of tabs disposed on the mounting ends of respective ground conductors of the plurality of conductive elements, and a plurality of transition portions connecting the plurality of tabs to the body.

Optionally, tabs of the plurality of tabs of the shielding member may be welded to respective ground conductors of the plurality of conductive elements.

Optionally, for each of the ground conductors: the mounting end may comprise a tab and a beam extending from the tab; and the beam may be configured to contact a shield of a cable such that the shielding member is electrically connected to the shield of the cable through the mounting end.

Optionally, the body of the shielding member may comprise a plurality of openings aligned in a line parallel to the column; each of the ground conductors may comprise an opening aligned with a respective opening of the body of the shielding member; and the lead assembly may comprise lossy material extending through the openings of the body of the shielding member and the openings of the ground conductors so as to couple the shielding member and the ground conductors.

Optionally, the mounting ends of the ground conductors may comprise openings; and the lead assembly may comprise a conductive hood having projections extending through the openings of the mounting ends of the ground conductors.

Optionally, the body of the shielding member may comprise an opening; the housing may comprise a protrusion extending through the opening of the body of the shielding member; and a transition portion of the shielding member may join the protrusion of the housing and a tab of the shielding member.

Optionally, the plurality of tabs may be a first plurality of tabs; and the shielding member may comprise a second plurality of tabs disposed on the mating ends of respective ground conductors of the plurality of conductive elements.

Optionally, the first plurality of tabs and the second plurality of tabs may be disposed in pairs; and each pair may have one of the first plurality of tabs disposed on the mounting end of a respective ground conductor and one of the second plurality of tabs disposed on the mating end of the respective ground conductor.

Optionally, the shielding member may be a first shielding member disposed on a first side of the housing; the lead assembly may comprise a second shielding member disposed on a second side of the housing opposite the first side; and the second shielding member may comprise a plurality of tabs disposed on the mounting ends of respective ground conductors.

Optionally, for each of the ground conductors, a portion of the mounting end may be sandwiched between a tab of the first shielding member and a tab of the second shielding member.

Some embodiments may relate to a cable assembly. The cable assembly may comprise a plurality of cables, each of the plurality of cables comprising at least one wire and a shield disposed around the at least one wire; a plurality of signal conductors, each of the plurality of signal conductors comprising a mating end, a mounting end opposite the mating end, and an intermediate portion extending between the mating end and the mounting end, the mounting end mounted with a wire of the at least one wire of a respective cable; a plurality of ground conductors, each of the plurality of ground conductors comprising a mating end, a mounting end opposite the mating ends, and an intermediate portion extending between the mating end and the mounting end, the mounting end electrically and mechanically connected to the shield of a respective cable; and a shielding member comprising a body and a plurality of tabs extending from the body, each of the plurality of tabs disposed on the mounting end of a respective ground conductor.

Optionally, the cable assembly may comprise a conductive hood holding the mounting ends of the plurality of ground conductors such that the mounting ends of the plurality of ground conductors press against the shields of the plurality of cables.

Optionally, the cable assembly may further comprise an insulative overmold molded over segments of the plurality of cables and partially surrounding the conductive hood.

Optionally, the cable assembly may comprise a lossy member coupling the intermediate portions of the plurality of ground conductors and the body of the shielding member.

Optionally, the plurality of tabs of the shielding member may be a first plurality of tabs; the shielding member comprising a second plurality of tabs extending from the body; and each of the second plurality of tabs may be disposed on the mating end of a respective ground conductor.

These techniques may be used alone or in any suitable combination. The foregoing summary is provided by way of illustration and is not intended to be limiting.

### BRIEF DESCRIPTION OF DRAWINGS

The accompanying drawings may not be drawn to scale. In the drawings, each identical or nearly identical component that is illustrated in various figures may be represented by a like numeral. For purposes of clarity, not every component may be labeled in every drawing. In the drawings:

FIG. 1A is a perspective view of a header connector mated to a complementary right angle connector, according to some embodiments.

FIG. 1B is a side view of two printed circuit boards electrically connected through the connectors of FIG. 1A, according to some embodiments.

FIG. 2A is a perspective view of the right angle connector of FIG. 1A, according to some embodiments.

FIG. 2B is an exploded view of the right angle connector of FIG. 2A, according to some embodiments.

FIG. 2C is a plan view of the right angle connector of FIG. 2A, illustrating a mounting interface of the right angle connector, according to some embodiments.

FIG. 2D is a top, plan view of a complementary footprint for the right angle connector of FIG. 2C, according to some embodiments.

FIG. 2E is a perspective view of an organizer of the right angle connector of FIG. 2A, showing a board mounting face, according to some embodiments.

FIG. 2F is an enlarged view of the portion of the organizer within the circle marked as “2F” in FIG. 2E, according to some embodiments.

FIG. 2G is a perspective view of the organizer of FIG. 2E, showing a connector attaching face, according to some embodiments.

FIG. 2H is an enlarged view of the portion of the organizer within the circle marked as “2H” in FIG. 2G, according to some embodiments.

FIG. 3A is a perspective, top, front view of a front housing of the right angle connector of FIG. 2A, according to some embodiments.

FIG. 3B is a top plan view of the front housing of FIG. 3A, according to some embodiments.

FIG. 3C is a front plan view of the front housing of FIG. 3A, according to some embodiments.

FIG. 3D is a rear plan view of the front housing of FIG. 3A, according to some embodiments.

FIG. 3E is a side view of the front housing of FIG. 3A, according to some embodiments.

FIG. 3F is a front perspective view of a support structure configured to support a connector housing, according to some embodiments.

FIG. 3G is a rear perspective view of the support structure of FIG. 3F, according to some embodiments.

FIG. 3H is a front perspective view of a connector housing before being severed from carrier strips, according to some embodiments.

FIG. 3I is a rear perspective view of the connector housing of FIG. 3H, according to some embodiments.

FIG. 4A is a perspective view of a core member, according to some embodiments.

FIG. 4B is a side view of the core member of FIG. 4A, according to some embodiments.

FIG. 4C is a perspective view of the core member of FIG. 4A after a first shot of lossy material and before a second shot of insulative material, according to some embodiments.

FIG. 4D is a perspective view of a core member, according to some embodiments.

FIG. 4E is a side view of the core member of FIG. 4D, according to some embodiments.

FIG. 4F is a perspective view of the core member of FIG. 4D after a first shot of lossy material and before a second shot of insulative material, according to some embodiments.

FIG. 5A is a perspective view of a dual insert-molded-lead-assembly (IMLA) assembly, according to some embodiments.

FIG. 5B is a top view of the dual IMLA assembly of FIG. 5A, illustrating Type-A and Type-B IMLAs attached to opposite sides of a core member, according to some embodiments.

FIG. 5C is a first side view of the dual IMLA assembly of FIG. 5A, illustrating a Type-A IMLA attached to the first side, according to some embodiments.

FIG. 5D is a second side view of the dual IMLA assembly of FIG. 5A, illustrating a Type-B IMLA attached to the second side, according to some embodiments.

FIG. 5E is a front view of the dual IMLA assembly of FIG. 5A, partially cut away, according to some embodiments.

FIG. 5F is a cross-sectional view along line P-P in FIG. 5D, illustrating a shield of the Type-A IMLA coupled to a shield of the Type-B IMLA through the core member of FIG. 4A, according to some embodiments.

FIG. 5G is an enlarged view of the portion of the dual IMLA assembly within the circle marked as “B” in FIG. 5F, according to some embodiments.

FIG. 5H is a cross-sectional view along line P-P in FIG. 5D, illustrating a shield of the Type-A IMLA coupled to a shield of the Type-B IMLA through the core member of FIG. 4D, according to some embodiments.

FIG. 5I is a perspective view of the Type-A IMLA of FIG. 5C, according to some embodiments.

FIG. 5J is an enlarged view of the portion of the mounting interface of the Type-A IMLA within the circle marked as “5J” in FIG. 5I, according to some embodiments.

FIG. 5K is a perspective view of the portion of the Type-A IMLA in FIG. 5J, according to some embodiments.

FIG. 5L is a perspective view of the portion of the Type-A IMLA in FIG. 5J with an organizer attached, according to some embodiments.

FIG. 5M is a plan view of the portion of the Type-A IMLA in FIG. 5L, according to some embodiments.

FIG. 5N is an exploded perspective view of the Type-A IMLA of FIG. 5I, with dielectric material hidden, according to some embodiments.

FIG. 5O is a partial cross-sectional view of the Type-A IMLA of FIG. 5N, according to some embodiments.

FIG. 5P is a plan view of the Type-A IMLA of FIG. 5I, with ground plates hidden, according to some embodiments.

FIG. 6A is a perspective view of a right angle connector, showing a dual IMLA assembly inserted in a front housing and with other dual IMLA assemblies hidden, according to some embodiments.

FIG. 6B is a perspective view of the right angle connector of FIG. 6A rotated 90 degrees clockwise, according to some embodiments.

FIG. 6C is an enlarged view of a portion of the right angle connector marked “6C” in FIG. 6B, according to some embodiments.

FIG. 7 is a partially exploded perspective view of a Type-A IMLA of the dual IMLA assembly of the right angle connector of FIG. 6A, according to some embodiments.

FIG. 8A is a first side view of the Type-A IMLA of FIG. 7, according to some embodiments.

FIG. 8B is a second side view of the Type-A IMLA of FIG. 7, according to some embodiments.

FIG. 8C is an enlarged view of a portion of the first side of the Type-A IMLA of FIG. 8A, showing a mating interface, according to some embodiments.

FIG. 8D is an enlarged view of a portion of the second side of the Type-A IMLA of FIG. 8B, showing the mating interface, according to some embodiments.

FIG. 8E is an enlarged view of a portion of the second side of the Type-A IMLA marked “8E” in FIG. 8C, according to some embodiments.

FIG. 9A is a perspective view of a first shielding member on the first side of the Type-A IMLA of FIG. 8A, according to some embodiments.

FIG. 9B is a perspective view of a second shielding member on the second side of the Type-A IMLA of FIG. 8B, according to some embodiments.

FIG. 9C is an enlarged view of a portion of the first shielding member of FIG. 9A, showing a mating interface, according to some embodiments.

FIG. 9D is an enlarged view of a portion of the second shielding member of FIG. 9B, showing the mating interface, according to some embodiments.

FIG. 9E is an enlarged view of a portion of the second shielding member marked “9E” in FIG. 9D, according to some embodiments.

FIG. 10 is an enlarged view of a mating interface between two IMLAs of the connectors of FIG. 1A, according to some embodiments.

FIG. 11A is a top view of the mated connectors of FIG. 1A, partially cut away, according to some embodiments.

FIG. 11B is an enlarged view of the portions of the mating interface within the circle marked as “Y” in FIG. 11A, according to some embodiments.

FIGS. 11C-11F are enlarged views of the mating interface of the connectors of FIG. 1A, at successive steps in mating, illustrating a method of mating the connectors, according to some embodiments.

FIG. 11G is an enlarged partial plan view of the mated connectors of FIG. 1A along the line marked “11G” in FIG. 11A, according to some embodiments.

FIG. 12 is a plot of near-end crosstalk (NEXT) across a frequency range of the connector of FIG. 6A, compared with a connector without connections between the shielding members and the ground conductors at their mating ends.

FIG. 13 is a plot of far-end crosstalk (FEXT) across a frequency range of the connector of FIG. 6A, compared with the connector without the connections between the shielding members and the ground conductors at their mating ends.

FIG. 14A is a perspective view of a cable connector, according to some embodiments.

FIG. 14B is a partially exploded view of the cable connector of FIG. 14A, according to some embodiments.

FIG. 15A is a perspective view of a Type-A cable IMLA of a dual IMLA cable assembly that may be in a cable connector like the cable connector of FIG. 14A, showing a side of the Type-A cable IMLA that faces away from a core member, according to some embodiments.

FIG. 15B is a perspective view of the Type-A cable IMLA of FIG. 15A, showing a side of the Type-A cable IMLA that faces towards the core member, according to some embodiments.

FIG. 15C is a partially exploded perspective view of the Type-A cable IMLA of FIG. 15B, according to some embodiments.

FIG. 16 is a perspective view of the Type-A cable IMLA of FIG. 15B, with a stress relief overmold and conductive hood hidden, according to some embodiments.

FIG. 17 is a perspective view of the Type-A cable IMLA of FIG. 16, with a lossy member and cables hidden, according to some embodiments.

FIG. 18 is a perspective view of shielding members of the Type-A cable IMLA of FIG. 15B, according to some embodiments.

FIG. 19 is a cross-sectional perspective view of a portion of the Type-A cable IMLA of FIG. 15B, along the line marked “19−19” in FIG. 15B, according to some embodiments.

FIG. 20A is a plot of NEXT across a frequency range of a cable connector with dual IMLA cable assemblies, each of which may have the Type-A cable IMLA of FIG. 15A and a corresponding Type-B cable IMLA, compared with cable connectors without connections between shielding members and ground conductors at their mating ends and/or cable mounting ends, measured when mated with the right angle connector of FIG. 6A.

FIG. 20B is a plot of FEXT across a frequency range of the cable connector with dual IMLA cable assemblies, compared with the cable connectors without the connections between the shielding members and the ground conductors at their mating ends and/or cable mounting ends, measured when mated with the right angle connector of FIG. 6A.

FIG. 21A is a plot of NEXT across a frequency range of the right angle connector of FIG. 6A, measured when mated with the cable connectors of FIG. 20A, respectively.

FIG. 21B is a plot of FEXT across a frequency range of the right angle connector of FIG. 6A, measured when mated with the cable connectors of FIG. 20A, respectively.

### DETAILED DESCRIPTION

The inventors have recognized and appreciated connector designs that increase performance of a high density interconnection system, particularly those that carry very high frequency signals that are necessary to support high data rates, including at 112 Gbps and above. The inventors have recognized and appreciated techniques to incorporate conductive shielding and lossy material in locations that enable operation at very high frequencies to support high data rates, for example, at or above 112 Gbps.

A connector may include conductive elements held in columns. In an example design, each column may be within a lead assembly, with multiple lead assemblies in a connector aligned in a row direction. Each lead assembly may include conductive elements held by an assembly housing and may include at least one shielding member. For example, a lead assembly may have first and second shielding members disposed on opposite sides of the assembly housing. Each conductive element may have a mating end extending out of a mating edge of the assembly housing, a mounting end extending out of a mounting edge of the assembly housing, and an intermediate portion joining the mating end and mounting end. The conductive elements may include ground conductors disposed between signal conductors.

High frequency performance may be enhanced by connecting the shielding members to the ground conductors at their mating ends. In some embodiments, for each lead assembly, the first shielding member may have first tabs disposed on the mating ends of respective ground conductors from a first side of the assembly housing; and the second shielding member may have second tabs disposed on the mating ends of respective ground conductors from a second side of the assembly housing. Such a configuration may improve both near-end crosstalk (NEXT) and far-end crosstalk (FEXT) by about 5 dB over a wide frequency range (e.g., from 0 to over 30 GHz).

In some embodiments, for each ground conductor, the respective first and second tabs may overlap with each other. Such a configuration may enable the first and second tabs to be electrically and mechanically connected to the ground conductor at one time through, for example, welding, such as resistance welding. In some embodiments, for each lead assembly, the first and second shielding members may include first and second beams connecting the first and second tabs to bodies of respective shielding members. The beams may be separated from an adjacent beam or a portion of the body of a respective shielding member by slots. The beams and slots may be sized to both provide tolerances for the welding and reduce crosstalk further. In some embodiments, the beam and corresponding slots may extend at least to respective inner walls.

For a connector with conductive elements that are attached to cables, high frequency performance may be enhanced by connecting the shielding members to ground conductors at their mounting ends or adjacent cable attachments. In some embodiments, for each lead assembly, the first shielding member may have mounting tabs disposed on the mounting ends of respective ground conductors from the first side of the assembly housing; and the second shielding member may have mounting tabs disposed on the mounting ends of respective ground conductors from a second side of the assembly housing. Such a configuration may improve both NEXT and FEXT for the cable connector, and improve both NEXT and FEXT for a connector mated with the cable connector. Connections at the mounting ends or adjacent cable attachments may be used instead of or in addition to connections near the mating ends of the conductive elements.

The lead assemblies may be attached to core members before being inserted between inner walls of a front housing. The core member may include features that would be difficult to mold in an interior portion of a housing, including relatively fine features that are conventionally included at the mating interface of a connector. The core member may have a body portion and a top portion. Body portions of lead assemblies may be attached to the body portions of the core members. A column of contact portions of the conductive elements, extending from the body portions of a lead assembly, may parallel the top portion of the core member. The top portion may be molded with fine features, including a long thin edge paralleling the tips of the conductive elements, which would be difficult to reliably mold as part of the housing.

In some embodiments, high frequency performance may be enabled by shielding throughout two mated connectors, which may both be formed with lead assemblies attached to core members. That shielding may extend from the mounting interfaces of a first connector to a first circuit board to which a first connector is mounted, through the first connector, through a mating interface to a second connector, through the body of the second connector and through a mounting interface of the second connector to a second circuit board to which the second connector is mounted. Shielding within the body portions of the lead assembly may be provided by shields attached to sides of the lead assemblies. At the mating interface, a shield may be in the interior of the top portion of the core member. In some embodiments, for each lead assembly, the beams connecting the shields to the mating ends of respective ground conductors, and corresponding slots separating the beams, may at least partially overlap the respective shields in the interior of the top portions of respective core members. The inventors have recognized and appreciated that such a configuration may reduce crosstalk further.

Effectiveness of the shielding may be increased by features that electrically connect the shield in the top portion of the core member to the shields of the lead assemblies. Further, features may be included to electrically couple the shields of the lead assemblies to ground planes on a surface of the printed circuit boards to which the connectors are mounted. In some embodiments, that electrical coupling may be formed with tines extending toward the printed circuit board and that are selectively positioned in regions of high electromagnetic radiation.

For example, in some embodiments, each lead assembly may include a signal lead and at least one ground plate. In some embodiments, the lead may be sandwiched by two ground plates. The mounting interface shielding for the connector may be formed by compressible members extending from the ground plates. The signal lead may include pairs of signal conductive elements. The compressible members extending from the ground plates may be positioned in groups. Each group of compressible members may at least partially surround a pair of signal conductive elements.

Further, the shield in the top portion of the core member may be electrically coupled to ground conductive elements in the lead assemblies. This coupling may be made through lossy material, which suppresses resonances that might otherwise occur as a result of distal ends of the top shields, away from connections to other grounded structures.

In some embodiments, intermediate portions of signal conductive elements within the bodies of the lead assemblies are shielded on two sides by lead assembly shields but contact portions are adjacent to only one top shield within the top portion of the core member. However, two-sided shielding may be provided throughout the signal path through two mated connectors. At the mating interface, mated contact portions of two mating connectors will be bounded on each of two sides by a top portion of the core members of one of the connectors. Thus, each contact portion will be bounded on two sides by a top shield, one from the connector of which it is a part and one from the connector to which it is mated. Providing shielding in the same configuration, such as two-sided shielding, throughout the signal path enables high integrity signal interconnects, as mode conversions and other effects that can degrade signal integrity at the transition between shielding configurations are avoided.

Such shielding may be simply and reliably formed in each of the multiple regions of the interconnection system. In some embodiments, a core member may be formed by a two-shot process. In the first shot, lossy material may be molded. In some embodiments, the lossy material may be selectively molded over conductive material. In the second shot, the lossy material may be selectively over molded with insulative material.

The foregoing techniques may be used singly or together in any suitable combination.

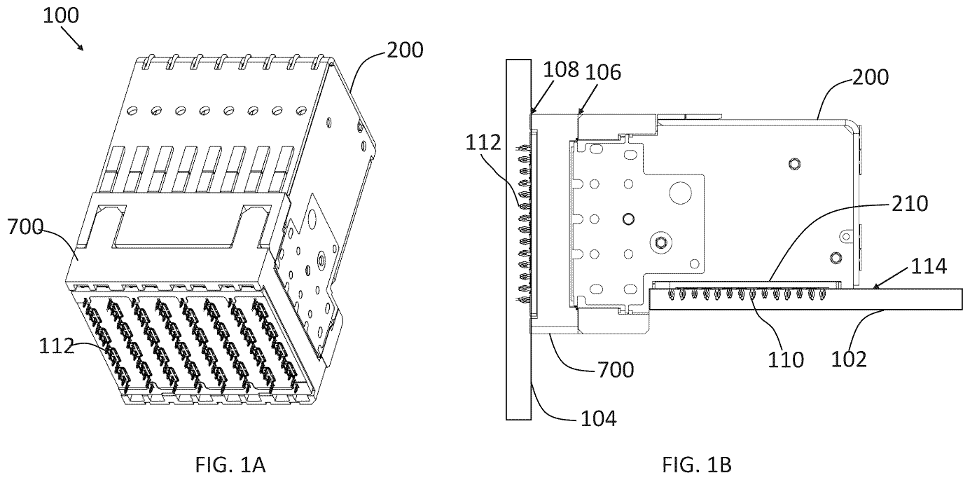

An exemplary embodiment of such connectors is illustrated in FIGS. 1A and 1B. FIGS. 1A and 1B depict an electrical interconnection system 100 of the form that may be used in an electronic system. Electrical interconnection system 100 may include two mating connectors, here illustrated as a right angle connector 200 and a header connector 700.

In the illustrated embodiment, the right angle connector 200 is attached to a daughtercard 102 at a mounting interface 114, and mated to the header connector 700 at a mating interface 106. The header connector 700 may be attached to a backplane 104 at a mounting interface 108. At the mounting interfaces, conductive elements, acting as signal conductors, within the connectors may be connected to signal traces within the respective printed circuit boards. At the mating interfaces, the conductive elements in each connector make mechanical and electrical connections such that the conductive traces in the daughtercard 102 may be electrically connected to conductive traces in the backplane 104 through the mated connectors. Conductive elements acting as ground conductors within each connector may be similarly connected, such that the ground structures within the daughtercard 102 similarly may be electrically connected to ground structures in the backplane 104.

To support mounting of the connectors to respective printed circuit boards, right angle connector 200 may include contact tails 110 configured to attach to the daughtercard 102. The header connector 700 may include contact tails 112 configured to attach to the backplane 104. In the illustrated embodiment, these contact tails form one end of conductive elements that pass through the mated connectors. When the connectors are mounted to printed circuit boards, these contact tails will make electrical connection to conductive structures within the printed circuit board that carry signals or are connected to a reference potential. In the example illustrated, the contact tails are press fit, “eye of the needle (EON),” contacts that are designed to be pressed into vias in a printed circuit board, which in turn may be connected to signal traces, ground planes or other conductive structures within the printed circuit board. However, other forms of contact tails may be used, for example, surface mount contacts, or pressure contacts.

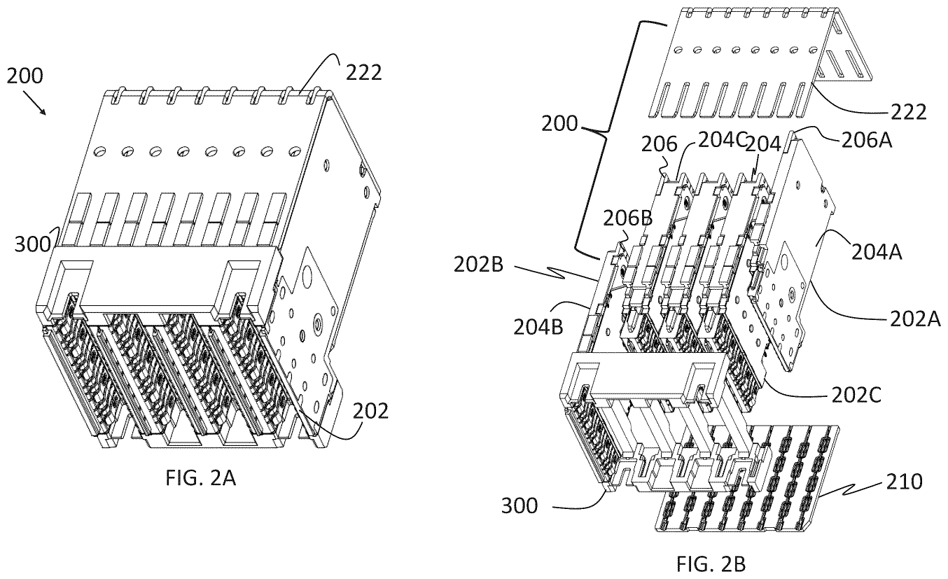

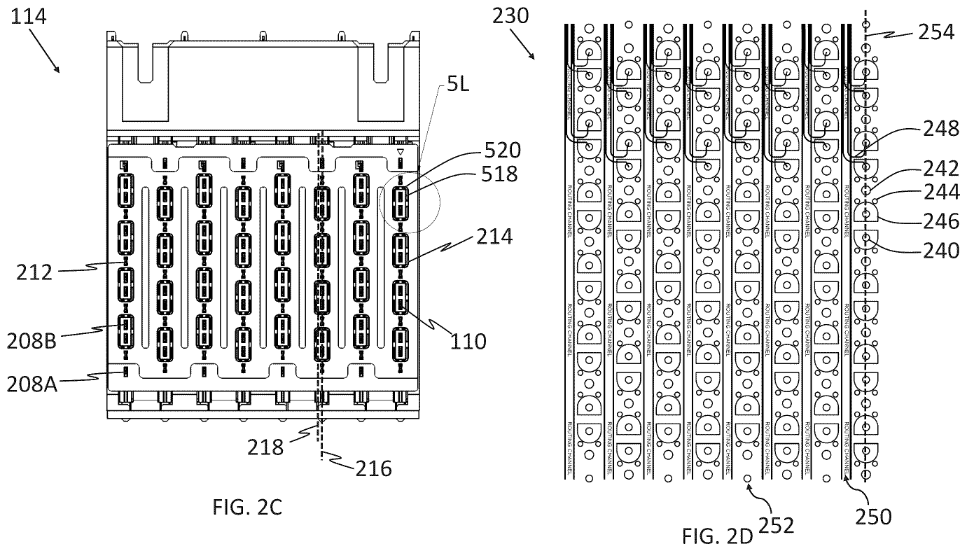

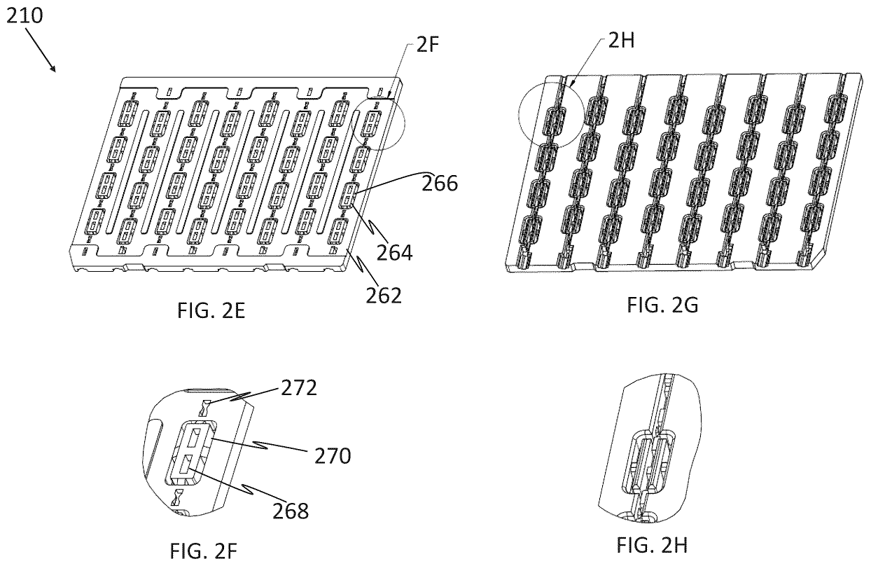

FIGS. 2A and 2B depict a perspective view and exploded view, respectively, of the right angle connector 200, according to some embodiments. The right angle connector 200 may be formed from multiple subassemblies, which in this example are T-Top assemblies, aligned side-by-side in a row. A T-Top assembly may include a core member 204 and at least one lead assembly 206 attached to the core member. These components may be configured individually for simple manufacture and to provide high frequency operation when assembled, as described in more detail below.

In the example of FIG. 2B, three types of T-Top assemblies are illustrated. T-Top assembly 202A is at a first end of the row, and T-Top assembly 202B is at a second end of the row. A plurality of a third type of T-Top assemblies 202C are positioned within the row between the T-Top assemblies 202A and 202B. The types of T-Top assemblies may differ in the number and configuration of lead assemblies.

A lead assembly may hold a column of conductive elements forming signal conductors. In some embodiments, the signal conductors may be shaped and spaced to form single ended signal conductors (e.g., 208A in FIG. 2C). In some embodiments, the signal conductors may be shaped and spaced in pairs to provide pairs of differential signal conductors (e.g., 208B in FIG. 2C). In the embodiment illustrated, each column has four pairs and one single-ended conductor, but this configuration is illustrative and other embodiments may have more or fewer pairs and more or fewer single ended conductors.

The column of signal conductors may include or be bounded by conductive elements serving as ground conductors (e.g., 212). It should be appreciated that ground conductors need not be connected to earth ground, but are shaped to carry reference potentials, which may include earth ground, DC voltages or other suitable reference potentials. The “ground” or “reference” conductors may have a shape different than the signal conductors, which are configured to provide suitable signal transmission properties for high frequency signals.

In the embodiment illustrated, signal conductors within a column are grouped in pairs positioned for edge-coupling to support a differential signal. In some embodiments, each pair may be adjacent at least one ground conductor and in some embodiments, each pair may be positioned between adjacent ground conductors. Those ground conductors may be within the same column as the signal conductors.

In some embodiments, a T-Top assembly may alternatively or additionally include ground conductors that are offset from the column of signal conductors in a row direction, which is orthogonal to the column direction. Such ground conductors may have planar regions, which may separate adjacent columns of signal conductors. Such ground conductors may act as electromagnetic shields between columns of signal conductors.

Conductive elements may be made of metal or any other material that is conductive and provides suitable mechanical properties for conductive elements in an electrical connector. Phosphor-bronze, beryllium copper and other copper alloys are non-limiting examples of materials that may be used. The conductive elements may be formed from such materials in any suitable way, including by stamping and/or forming.

The insert molded lead assemblies may be constructed by stamping conductive elements from a sheet of metal. Curves and other features of the conductive elements may also be formed, as part of the stamping operation or in a separate operation. The signal conductors and ground conductors of a column may be stamped from a sheet of metal, for example. In the stamping operation, portions of the metal sheet, serving as tie bars between the conductive elements, may be left to hold the conductive elements in position. The conductive elements may be overmolded by plastic, which in this example is insulative and serves as a portion of the connector housing, which holds the conductive elements in position. The tie bars may then be severed.

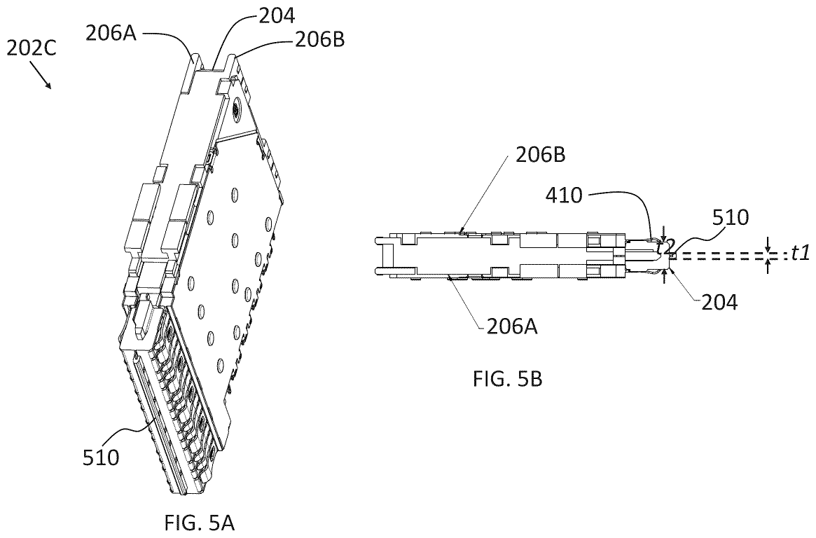

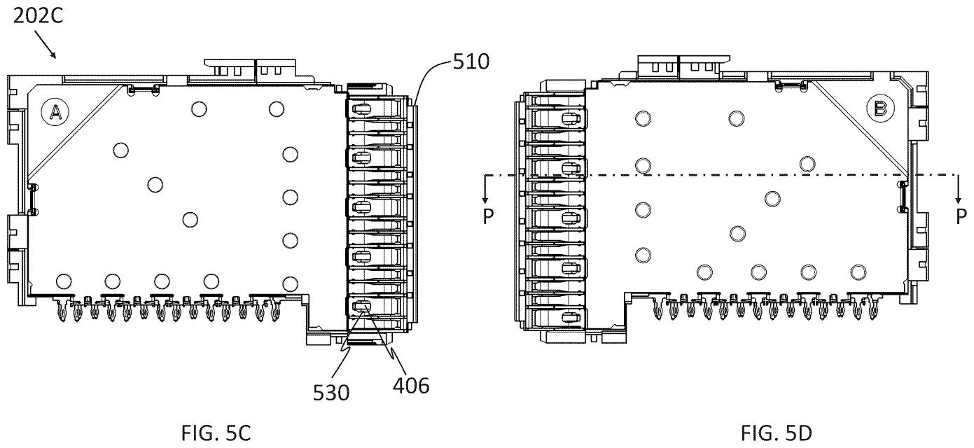

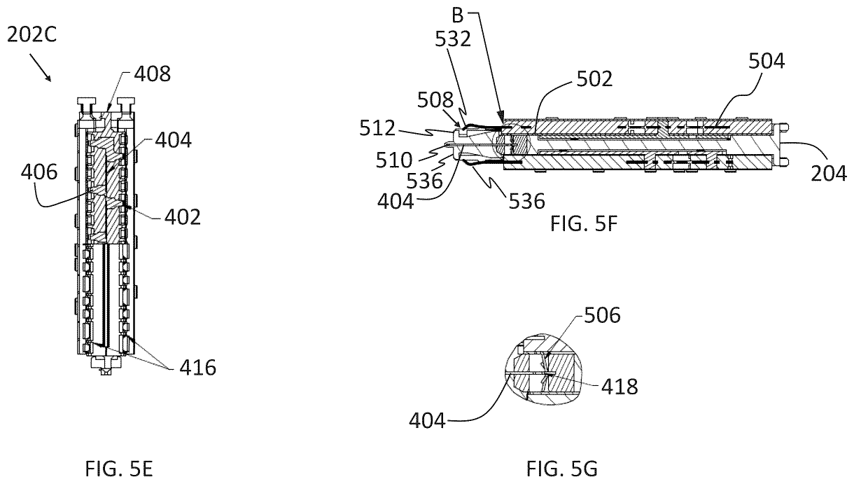

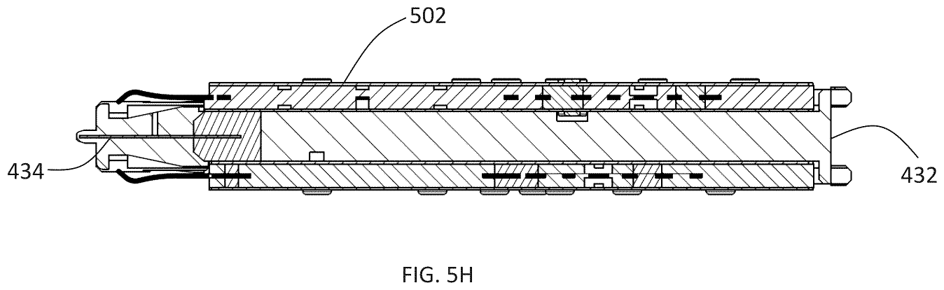

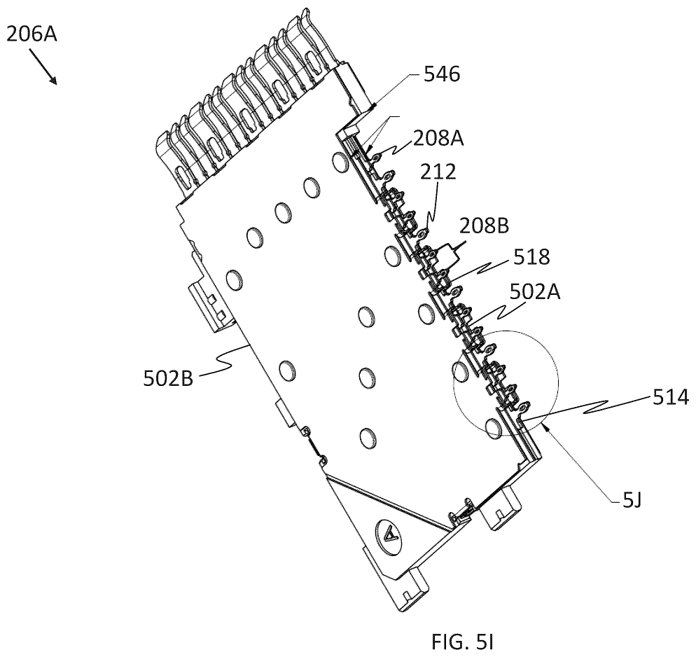

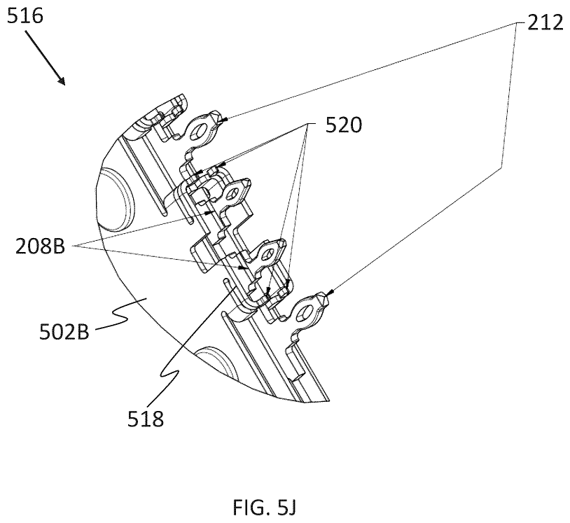

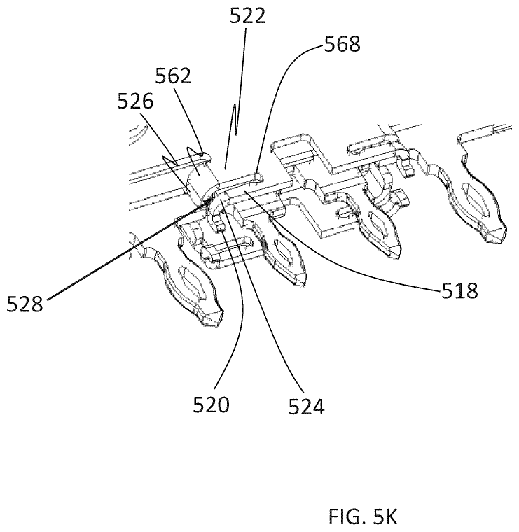

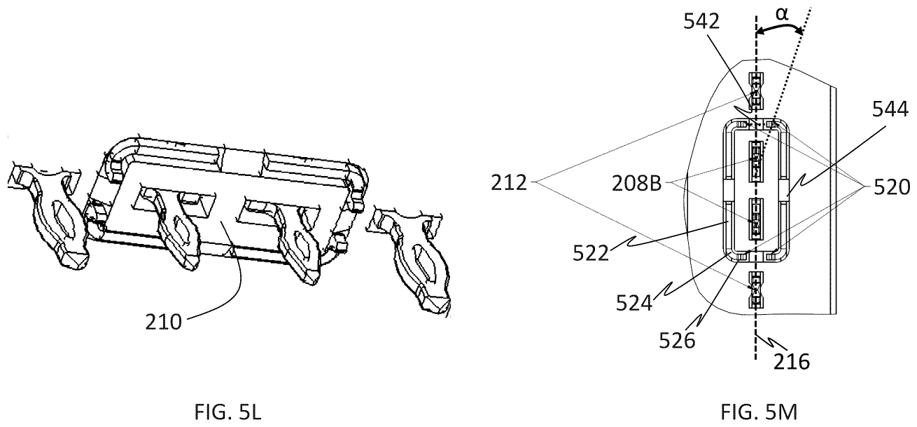

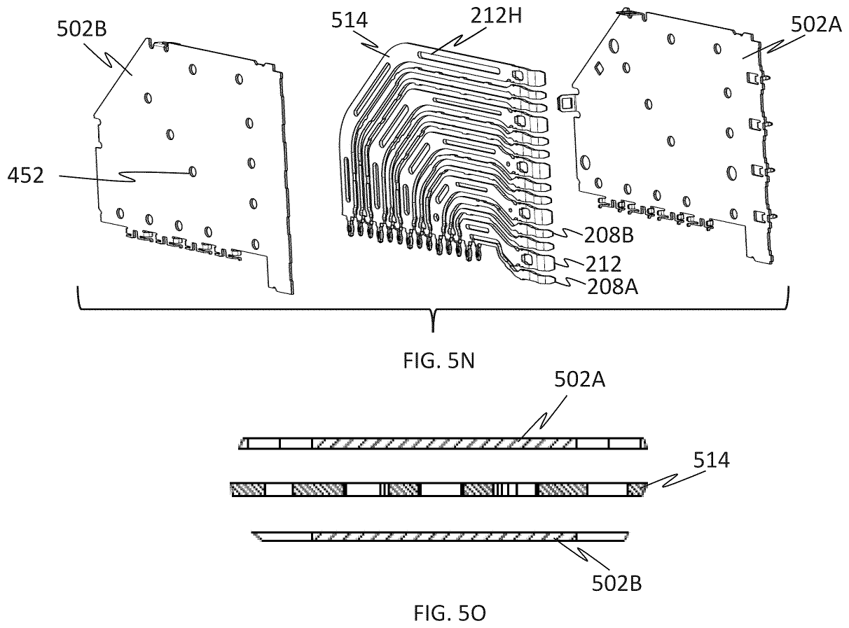

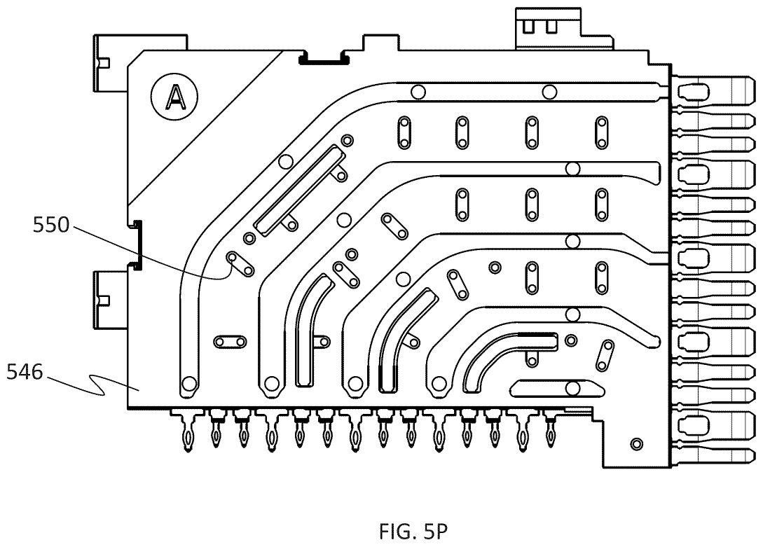

In some embodiments, the signal and ground conductors of the leadframe may be held stable by pinch pins. The pinch pins may extend from the surfaces of a mold used in the insert molding operation. In a conventional insert molding operation, pinch pins from opposing sides of a mold may pinch signal conductors and ground conductors between them. In this way, the position of the signal and ground conductors with respect to the insulative housing molded over them is controlled. When the mold is opened, and the IMLA is removed, holes (e.g., holes 550 in FIG. 5P) in the insulative housing in the locations of the pinch pins remain. These holes are generally regarded as non-functional for the completed IMLA as they are made with pins that are of small enough diameter that they do not materially impact the electrical properties of the signal conductors.

In some embodiments, however, the number of pinch pins pinching each signal conductor may be selected so as to provide a functional benefit. As a specific example, in a conventional connector the number of pinch pins, and the resulting number of pinch pin holes, may be the same for each signal conductors of a pair of adjacent signal conductors. In some connectors, such as right angle connectors, one of the signal conductors of a pair may be longer than the other. More pinch pins may be used for the longer signal conductor of each pair. More pinch pins results in more pinch pin holes and a lower effective dielectric constant of the housing along the length of the longer signal conductor, as compared to the shorter. This configuration may result in more pinch pin holes along the longer conductor than is needed, but may also reduce intrapair skew and otherwise improve performance of the connector.

In some embodiments, the conductive elements in different ones of the lead assemblies may be configured differently. In this example, there are two types of lead assemblies, differing in the position of the signal and ground conductors within the column such that, when the two types of lead assemblies are positioned side by side, a ground conductive element in one lead assembly (e.g., Type-A IMLA 206A) is adjacent a signal conductive element in the other lead assembly (e.g., Type-B IMLA 206B). In the illustrated example, Type-A IMLAs are positioned to the left of a core member (when the connector is viewed from a perspective looking toward the mating interface). Type-B IMLAs are positioned to the right of a core member. This configuration may reduce the column-to-column cross talk between lead assemblies.

In the illustrated embodiment, the right angle connector 200 includes a single Type-A IMLA T-Top assembly 202A at a first end of a row that the T-Top assemblies 202 align along, a single Type-B IMLA T-Top assembly 202B at a second end of the row, opposite the first end of the row, and multiple dual IMLA T-Top assemblies 202C between the first and second ends. The Type-A IMLA T-Top assembly 202A has a single lead assembly 206A attached to a core member. The Type-B IMLA T-Top assembly 202B has a single lead assembly 206B attached to a core member.

Accordingly, each of the Type-A IMLA T-Top assembly and the Type-B IMLA T-Top assembly has a side not attached with a lead assembly. This configuration allows using the open sides of the core members of the Type-A IMLA T-Top assembly 202A and the Type-B IMLA T-Top assembly 202B as part of the connector housing.

A core member of a dual IMLA T-Top assembly 202C may have two lead assemblies, here a Type-A IMLA and a Type-B IMLA, attached to opposite sides of the core member. In some embodiments, the conductive elements in the two lead assemblies may be configured the same.

One or more members may hold the T-Top assemblies in a desired position. For example, a support member 222 may hold top and rear portions, respectively, of multiple T-Top assemblies in a side-by-side configuration. The support member 222 may be formed of any suitable material, such as a sheet of metal stamped with tabs, openings or other features that engage corresponding features on the individual T-Top assemblies. As another example, support members may be molded from plastic and may hold other portions of the T-Top assemblies and serve as a portion of the connector housing, such as front housing 300.

FIG. 2C depicts the mounting interface 114 of the right angle connector 200, according to some embodiments. The contact tails 110 of the connector 200 may be arranged in an array including multiple parallel columns 216, offset from one another in a row direction, perpendicular to the column direction. Each column 216 of contact tails 110 may include ground contact tails 212 disposed between pairs of signal contacts 208B. In some embodiments, all or a portion of the signal contacts 208B may be manufactured thinner than the ground contacts. Thinner signal contacts may provide a desired impedance for the signal contacts. The ground contact tails 212 may be thicker in order to provide good mechanical strength.

In some embodiments, the signal contacts may be formed in the same lead by stamping a sheet of metal into the desired shape. Nonetheless, all or portions of the signal contacts may be thinner than the ground contacts by reducing their thickness, such as by coining the signal contacts. In some embodiments, the signal contacts may be between 75 and 95% of the thickness of the ground contacts. In other embodiments, the signal contacts may be between 80% and 90% of the thickness of the ground contacts.

In some embodiments, intermediate portions of the signal contacts may be the same thickness as intermediate portions of the ground contacts. The tails of the signal contacts nonetheless may be of reduced thickness. In an embodiment in which the tails of the signal contacts are configured for press fit mounting, such a configuration may enable the tails of the signal contacts to fit within relatively small holes. The holes, for example, may be formed with a drill of 0.3 mm to 0.4 mm diameter, or 0.32 mm to 0.37 mm, such as a 0.35 mm drill. The finished hole size may be 0.26 mm+/−10%. In contrast, the ground tails may be inserted into a larger hole. For example, the hole might be formed with a 0.4 mm to 0.5 mm drill, such as a 0.45 mm drill, with a finished diameter of 0.31 mm to 0.41 mm, for example. The contact tails may be configured with a width larger than the finished diameter of the respective holes into which they are inserted and to be compressible to a width that is the same as or smaller than the finished hole diameter.

Forming contact tails with these dimensions may reduce parasitic capacitance between signal conductors and adjacent grounds in an assembly in which such a connector is used, for example. Nonetheless, the grounds may provide sufficient attachment force to retain the connector on a printed circuit board to which the connector is mounted. Further, by stamping the signals and grounds, though of different finished thicknesses, from the same sheet of metal, precise positioning of the signal tails relative to ground tails may be provided. Positions of the signal contact tails, for example, may be within 0.1 mm or less of their designed position, as measured relative to position of the tails of the ground contacts. Such a configuration simplifies attachment of the connector to the printed circuit board. The more robust ground contact tails may be used to align the connector with respect to the printed circuit board by engaging their respective holes. The signal contact tails will then be sufficiently aligned with their respective holes to enter the holes with little risk of damage when the connector is pressed into the board. As a result, the connector may be mounted with a simple tool that presses the connector perpendicularly with respect to the printed circuit board, without the need for expensive fixtures or other tooling.

The ground contact tails and/or signal contact tails may be configured to support mounting of the connector to a printed circuit board in this way. As is visible, for example in FIG. 5I, the ground contacts tails, may be longer than the signal contact tails. The ground contacts may be longer by an amount such that they enter their respective holes in the printed circuit board before the tips of the signal contacts reach a plane parallel to the surface of the printed circuit board. In the embodiment illustrated, the contact tails taper towards the tips. In the illustrated embodiment, the ground contact tails have a body with an opening therethrough, which enables compression of the tail upon insertion into a hole. The distal portion of the tail is elongated such that it is narrower than the body and may readily enter a hole on a printed circuit board. The signal contacts have a shorter elongated portion at their distal ends.

The connector 200 may include a mounting interface shielding interconnects 214 configured to make electrical connections between the ground conductors acting as shields between columns of signal conductors within the connector and ground structures with the PCB to which the connector is mounted. Shielding interconnects 214 are adjacent to and/or make contact with a flooded ground plane of the daughtercard 102. In this example, the mounting interface shielding interconnects 214 include a plurality of tines 520 configured to be adjacent to and/or make physical contact with the flooded ground plane of the daughtercard.

The tines 520 may be positioned to also reduce radiated emissions at the mounting interface 114. In some embodiments, the tines 520 may be arranged in an array including columns 218. Neighboring columns 216 of the contact tails 110 may be separated by one or more columns 218 of the tines 520 of the interface shielding interconnect 214. The tines 520 may have a portion in a same plane as a body of a ground conductor acting as a shield between columns within the connector. Accordingly, a portion of the tines 520 may be offset from the contact tails 110 in a row direction that is perpendicular to the column direction. Additionally, each of the tines may include a portion that is bent out of that plane towards to column of signal conductors. That portion of the tines 520 may be positioned between a ground contact tail 212 and a signal contact tail 208B.

In some embodiments, the mounting interface shielding interconnect 214 may be compressible. A compressible interconnect may generate a force that makes a reliable contact to the ground plane on the printed circuit board, such as by generating contact force and/or enabling contact to be made despite tolerance in the position of the connector with respect to the surface of the printed circuit board. In some embodiments, some or all of the tines 214 may make physical contact with the daughtercard 102 when the connector 200 is mounted to the daughtercard 102. Alternatively or additionally, some or all of the tines 214 may be capacitively coupled to the ground plane on daughtercard 102 without physical contact and/or a sufficient number of the tines 214 may be coupled to the ground plane to achieve the desired effect.

In some embodiments, the mounting interface shielding interconnect 214 may extend from internal shields of the connector 200 and may be formed integrally with the internal shields of the connector 200. In some embodiments, the mounting interface shielding interconnect 214 may be formed by compressible members extending from internal shields of the lead assemblies 206, for example, compressible members 518 illustrated in FIG. 5I and/or may be a separate compressible member.

FIG. 2D depicts, partially schematically, a top view of a footprint 230 on the daughtercard 102 for the right angle connector 200, according to some embodiments. The footprint 230 may include columns of footprint patterns 252 separated by routing channels 250. A footprint pattern 252 may be configured to receive mounting structures of a lead assembly (e.g., contacts tails 110 and compressible members 518 of a lead assembly 206).

The footprint pattern 252 may include signal vias 240 aligned in a column 254 and ground vias 242 aligned to the column 254. The ground vias 242 may be configured to receive contact tails from ground conductive elements (e.g., 212). The signal vias 240 may be configured to receive contact tails of signal conductive elements (e.g., 208A, 208B). As illustrated, the ground vias 242 may be larger than the signal vias 240. When a connector is being mounted to a board, larger and more robust ground contact tails may align the connector with the bigger ground vias. This aligns the signal contact tails with the smaller signal vias. This configuration may increase the economics of an electronic assembly by, for example, enabling a conventional mounting method such as press fit with flat-rock tooling, and avoiding expensive special tooling that might otherwise be necessary to mount the connector to the printed circuit board without damage to the thinner signal contact tails that might otherwise be susceptible to damage.

The signal vias 240 may be positioned in respective anti-pads 246. The printed circuit board may have layers containing large conductive regions interspersed with layers patterned with conductive traces. The traces may carry signals and the layers that predominately sheets of conductive material may serve as grounds. Anti-pads 246 may be formed as openings in the ground layers such that the electrically conductive material of a ground layer of the PCB is not connected to the signal vias. In some embodiments, a differential pair of signal conductive elements may share one anti-pad.

The via pattern 252 may include ground vias 244 for the compressible members 518 of the mounting interface shielding interconnect 214. In some embodiments, the ground vias 244 may be shadow vias configured to enhance electrical connection between internal shields of the connector to the PCB, without receiving ground contact tails. In some embodiments, the shadow vias may be below and/or be compressed against by the compressible members 518, for example, by the tines 520 of the compressible members 518 (FIG. 5K). The ground vias 244 may be sized and positioned to provide enough space between footprint patterns 252 such that traces 248 can run in the routing channel 250. In some embodiments, the ground vias 244 may be offset from the column 254. In some embodiments, the ground vias 244 may be within a width of the anti-pads 246 such that the width of the anti-pads 246 defines the width of the column footprint pattern 252.

It should be appreciated that although some structures such as the traces 248 are illustrated for some of the signal vias, the present application is not limited in this regard. For example, each signal via may have corresponding breakouts such as traces 248.

FIG. 2D shows some of the structures that may be in a PCB, including structures that might be visible on the surface of the printed circuit board and some that might be in the interior layers of the PCB. For example, the anti-pads 246 may be formed in a ground plane on a surface of a printed circuit board and/or may be formed in some or all of the ground planes in the inner layers of the PCB. Moreover, even if formed on the surface of the PCB, the ground plane might be covered by a solder mask or coating such that it is not visible. Likewise, traces 248 may be on one or more inner layers.

Referring back to FIG. 1B and FIG. 2B, the connector 200 may include an organizer 210, which may be configured to hold the contact tails 110 in an array. The organizer 210 may include a plurality of openings that are sized and arranged for some or all of the contact tails 110 to pass through them. In some embodiments, the organizer 210 may be made of a rigid material and may facilitate alignment of the contact tails in a predetermined pattern. In some embodiments, the organizer may reduce the risk of damage to contact tails when the connector is mounted to a printed circuit board by limiting variations in the positions of the contact tails to the locations of the slots, which may be reliably positioned.

An organizer may be used in conjunction with thin and/or narrow signal contact tails, as described elsewhere herein. In some embodiments, the organizer may be used in conjunction with a lead in which ground contact tails position are used to position the lead with respect to a printed circuit board. In the illustrated embodiment, the openings are elongated in a column direction. The openings may be sized to provide greater limitation on movement of the contact tails in a direction perpendicular to the column direction than in the column direction. The openings may ensure alignment, in a direction perpendicular to the column direction, of the contact tails with openings in the printed circuit board. As described above, alignment of the ground contacts in a lead assembly with holes in the printed circuit board may lead to alignment in the column direction of all of the contact tails in the lead assembly. In combination, these two techniques may provide accurate alignment in two dimensions of the contact tails with holes of the printed circuit board, enabling thin and narrow signal contact tails, with correspondingly small diameter signal holes in the printed circuit board with low risk of damage.

In some embodiments, the organizer may reduce airgaps between the connector and the board, which can cause undesirable changes in impedance along the length of conductive elements. An organizer may also reduce relative movement among the T-Top assemblies 202. In some embodiments, the organizer 210 may be made of an insulative material and may support the contact tails 110 as a connector is being mounted to a printed circuit board or keep the contact tails 110 from being shorted together. In some embodiments, the organizer 210 may include lossy material to reduce degradation in signal integrity for signals passing through the mounting interface of the connector. The lossy material may be positioned to be connected to or to preferentially couple to ground conductive elements passing from the connector to the board. In some embodiments, the organizer may have a dielectric constant that matches the dielectric constant of a material used in the front housing 300 and/or the core member 204 and/or the lead assemblies 206.

In the embodiment illustrated in FIG. 1B, the organizer is configured to occupy space between the T-Top assemblies 202 and the surface of the daughtercard 102. To provide such a function, for example, the organizer 210 may have a flat surface for mounting against the daughtercard 102. An opposing surface, facing the T-Top assemblies 202, may have projections or any other suitable profile to match a profile of the T-Top assemblies. In this way, the organizer 210 may contribute to a uniform impedance along signal conductive elements passing through the connector 200 and into the daughtercard 102. According to some embodiments, FIG. 2E and FIG. 2G are perspective views of the organizer 210 of the right angle connector 200, showing a board mounting face and a connector attaching face, respectively. FIG. 2F and FIG. 2H are enlarged views of the portions of the organizer 210 within the circle marked as “2F” in FIG. 2E and the circle marked as “2H” in FIG. 2G, respectively.

The organizer 210 may include a body 262 and islands 264 physically connected to the body 262 by bridges 266. The islands 264 may include slots 268 sized and positioned for signal contact tails to pass therethrough. Slots 270 for interface shielding interconnects 214 to pass therethrough are formed between the body 262 and the islands 264 and separated by the bridges 266. The body 262 may include slots 272 between adjacent islands configured for ground contact tails to pass therethrough.

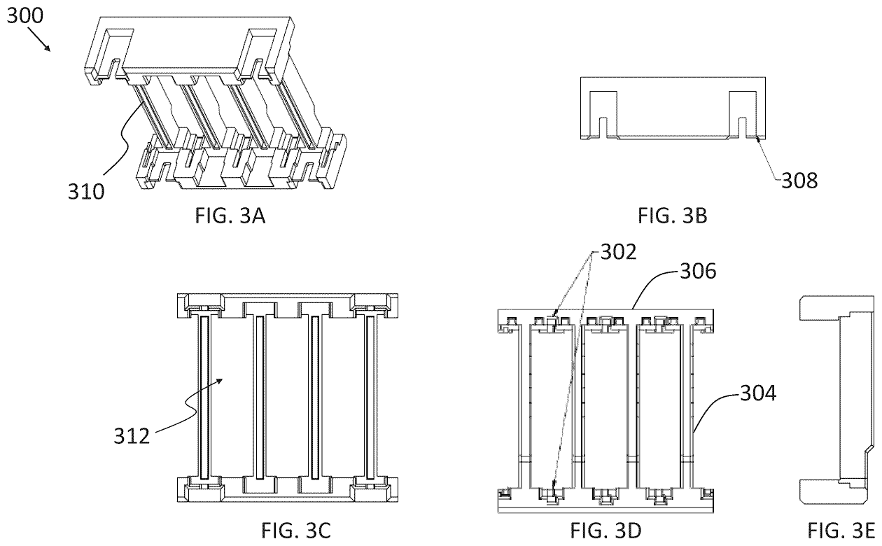

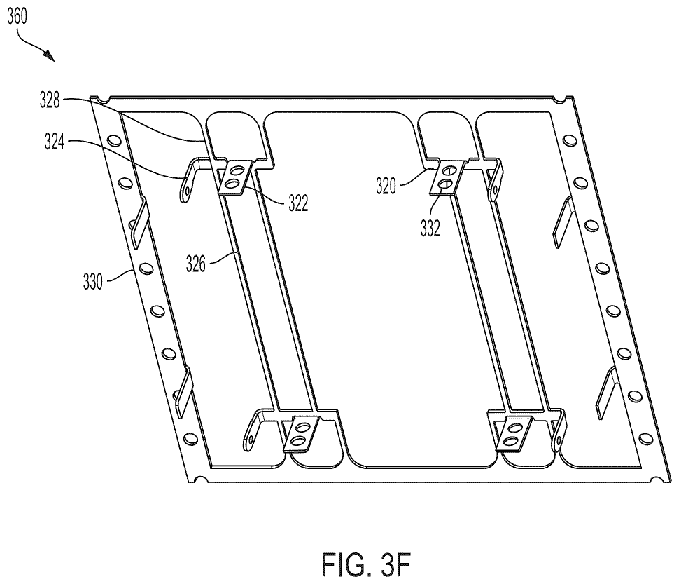

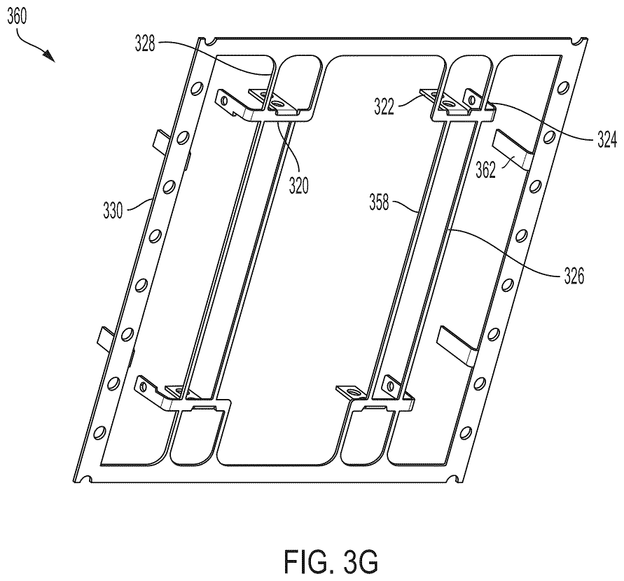

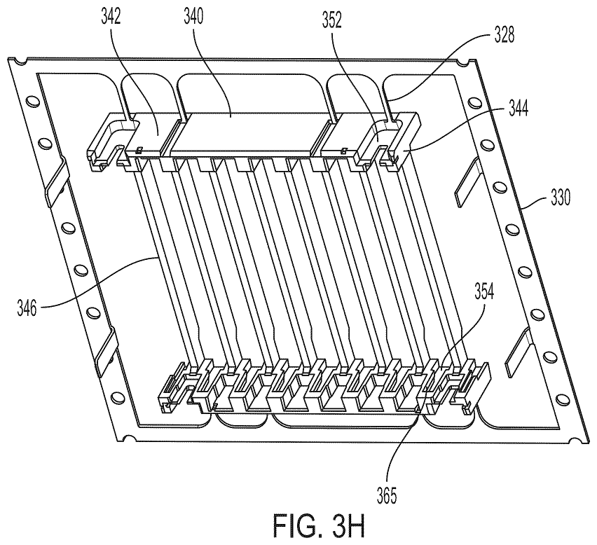

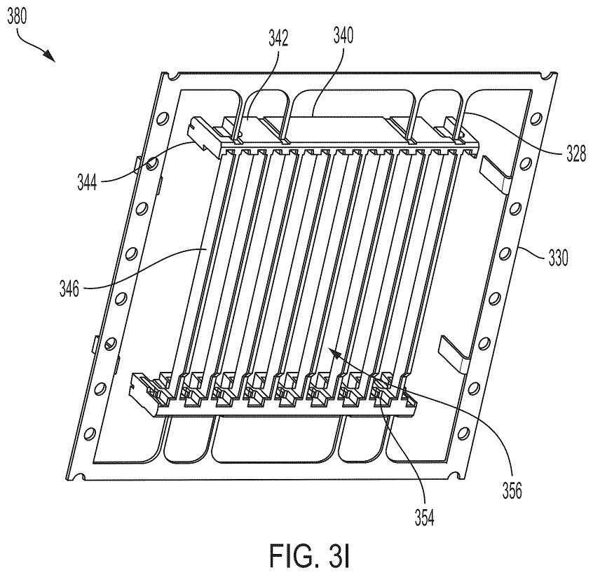

A front housing 300 may be configured to hold mating regions of the T-Top assemblies. A method of assembling the right angle connector 200 may include inserting the T-Top assemblies 206 into the front housing 300 from the back as illustrated in FIG. 2B. FIGS. 3A-3E depict views of the front housing 300 from various perspectives, according to some embodiments. The front housing may have walls that bound a mating interface region of the connector. In this example, the front housing 300 may include inner walls 304 configured to separate adjacent T-Top assemblies, and outer walls 306 extending substantially perpendicular to the length of the inner walls and connecting the inner walls. The inner walls 304 may extend between an upper outer wall and a lower outer wall. The outer walls 306 may have alignment features 302 between adjacent inner walls. The alignment features 302 are in pairs and configured to engage matching features of the core members. The T-Top assemblies 206 may be held in the front housing 300 through the alignment features 302, which enables the inner walls and outer walls having substantially similar thickness and simplifies the housing mold, compared to conventional connectors, which include thin inner walls and complex, thin features to hold mating portions of conductive elements.

The front housing may be formed of a dielectric material such as plastic or nylon. Examples of suitable materials include, but are not limited to, liquid crystal polymer (LCP), polyphenyline sulfide (PPS), high temperature nylon or polyphenylenoxide (PPO) or polypropylene (PP). Other suitable materials may be employed, as aspects of the present disclosure are not limited in this regard.

The inventors have recognized and appreciated that parts of a connector housing such as the inner walls may bow or twist under forces that might occur during the manufacture or use of the connector. This may be because the volume of the material needed to form the connector housing to hold high speed lead assemblies close together to provide a high density interconnect is smaller than in a conventional connector housing. A connector housing of conventional design therefore may lack strength to support connector modules such as the T-Top assemblies. Such bowing or twisting may move the connector modules out of their designed positions or otherwise create problems.

The inventors have recognized and appreciated that a connector housing may be reinforced by forming one or more support members and then molding a material over the support members. In some embodiments, the support member may be formed of metal or any other material that provides suitable mechanical properties. The overmolding material may be dielectric material in some embodiments or may be or include lossy material in some embodiments. Accordingly, a connector housing may include at least one support member of a first material fully or partially encapsulated in a portion of a second material, such as an insulative overmold.

In accordance with some embodiments, a front housing having an embedded skeleton is shown in FIGS. 3F-3G. FIGS. 3F and 3G depict front and rear perspective views of a metal stamping 360, respectively. The skeleton may include one or more members in the plane of the metal from which stamping 360 is formed. In this example, support members 320 and/or other elongated members 326 are in that plane. In some embodiments, one or more members may bend out of that plane. In this example, flanges bend out of the plane at a right angle, but components may bend out of the plane at other angles. Also in this example, the flanges extend from members within the plane, but in other embodiments flanges may extend from other portions of the stamping 360.

The stamping 360 may include carrier strips 330, which are here shown attached to support members 320 through tie bars 328. Alternatively or additionally, stamping 360 may include tie bars establishing the relative position of members forming the skeleton. For example, in some embodiments, a tie bar 358 may connect two members of the skeleton to ensure that the spacing between those members is maintained during an overmolding operation.

In this example, the skeleton within stamping 360 is configured to reinforce a front housing 340. A front housing 340, formed by molding over the support members 320, is shown in FIGS. 3H and 31. In the illustrated example, the carrier strips 330 include features that aid in the insert molding operation including, for example, holes for positioning the stamping 360 relative to a mold. Although FIG. 3F illustrates one stamping 360 for a connector housing, in some embodiments, a long strip of metal may be stamped with multiple stampings, each for a connector housing. That long strip may then be wound on a reel, and then fed into a molding process. Tabs 362 extending perpendicularly from the carrier strips may protect the support structure from damage when wound on the reel. After molding the multiple connector housings simultaneously or in sequence, individual connector housings may be obtained by severing the ties bars.

The members of stamping 360 forming a skeleton may be stamped to align with locations of a connector housing that are prone to bowing or twisting and/or locations of the connector housing that can be reinforced to prevent bowing or twisting at other locations. For example, a front housing of a connector may have outer walls with a plurality of inner walls extending between two opposing outer walls. The inner walls may be spaced to provide openings between adjacent inner walls. The openings may be sized to receive a mating interface of a mating connector. To enable a high density of mating contacts, the inner walls may be long and thin so as to enable the mating interface to provide multiple closely spaced columns of mating contact portions. The aspect ratio of the inner walls, as measured by the ratio of the longest dimension to the shortest may be greater than 10:1, such as between 10:1 and 100:1, or between 10:1 and 50:1 or 10:1 and 25:1, or 15:1 and 30:1, in various embodiments. Inner walls with such a large aspect ratio may allow the front housing to bow or otherwise deform.

In the example illustrated in FIGS. 3F and 3G, the stamping includes four support members 320. An end wall flange 322 and a sidewall flange 324 may extend from each support member 320. Two support members 320 may be joined by one or more elongated pieces 326. The flanges 322 and 324 may extend in a direction perpendicular to the direction that elongated pieces 326 extend. Such a 3D configuration may provide more structural strength than a 2D structure. The flanges may include features such as holes 332, enabling a material to flow through during molding such that the flanges are more securely locked into the molded material.

A front housing 340 may be formed by overmolding insulative material on a support structure, such as the support structure in the stamping 360 of FIGS. 3F and 3G. Overmolding may result in the members of the support structure being fully or partially encapsulated by the overmolded material. In the illustrative embodiment, the overmolding material is insulative, and the skeleton is sufficiently encapsulated by the insulative overmold that the metal of skeleton is insulated from any conductive members of the lead assemblies attached to front housing 340.

In the example illustrated in FIGS. 3H and 31, the front housing 340 includes outer walls 342, side walls 344, and inner walls 346. End wall flanges 322 may be embedded in and support the outer walls 342. Sidewall flanges 324 may be embedded in and support the side walls 344. Each elongated piece 326 may be embedded in and support an inner walls 346. In the illustrated embodiment, only a subset of the inner walls in the front housing include an elongated piece 326.

As discussed above, the locations of the features of the skeleton, such as flanges 322, 324 and elongated pieces 326 may be selectively disposed to provide a more robust component while not materially interfering with the flow of insulative material during a subsequent molding operation. In the illustrated example, the elongated pieces 326 are disposed to support the two outermost inner walls 346. Support members 320 each extend over only a portion of the length of an outer wall. In some embodiments, members forming the skeleton may extend through a greater portion of the connector component. For example, a support member or multiple support members collectively may extend over all or substantially all the length of each outer wall. As another example, the skeleton may include additional elongated pieces, with additional pieces aligned to be overmolded by additional inner walls, respectively. For example, an elongated structure may, instead of or in addition to a tie bar 358 that is offset from an inner wall, align with the inner wall adjacent an outermost inner wall. In this way, members of the skeleton may reinforce the four outermost inner walls. In other embodiments, additional elongated members may be present such that the skeleton may reinforce all or any number of the inner walls in the front housing 340.

In other embodiments, other connector housing portions may have different sizes and numbers of skeletal members. For example, the front housing 340 has four support members 320 embedded within it, one on each corner of the front housing 340. In some embodiments, regardless of the size of a connector housing, skeletal members may extend through additional portions. For example, an additional support member 320 may extend through an elongated piece 326 in a central portion of the housing.

Similarly, additional flanges may be included. Sidewall flanges 324 may be embedded in a portion of the side wall 344 of the front housing 340 that is thinner than other portions of the side wall 344. For connectors with other thinned sidewall sections, other flanges may be embedded in those thinned sections, for example.

The front housing 340 may include fine features such as the mating features 352 configured to mate with matching features of a mating connector housing. There may be support members embedded in the material forming the fine features to provide additional strength. For example, the mating features 352 may be formed by material molded around the end wall flange 322.

Similar to the front housing 300 illustrated in FIGS. 3A-3E, the front housing 340 may include openings 356, into which connector modules such as the T-Top assemblies may be inserted. The front housing 340 may also include alignment features 354 for the accuracy of the insertions. In the illustrated example, alignment features 354 include channels 365 into which projecting portions of the connector modules such as extensions 510 in FIG. 5B may be slid.

In the illustrated example, tie bar 358 may be severed, for example, after the overmolding operation. Other tie bars 328 may be retained such that the molded housing may be handled with the carrier strips but may be severed to free the molded part from the carrier strip before use.

It should be appreciated that the front housing 340 illustrated in FIGS. 3H and 31 has more openings than the front housing 300 illustrated in FIGS. 3A-3E. Front housing may be used in a connector module that incorporates more lead assemblies than front housing 300. A skeleton as described herein may be used to enable large connectors such as, for example, connectors with six or more lead assemblies or, in some embodiments, eight or more lead assemblies. Each of the lead assemblies may provide at least one column of conductive elements for carrying signals. In embodiments as described herein, each lead assembly may provide two columns of conductive elements. Moreover, with support provided by a skeleton as described herein, each lead assembly may be long enough to support multiple pairs of signal conductors. For example, there may be at least 6 or 8 pairs of signal conductors along each column. Despite the density of such a connector, it may nonetheless be mechanically robust. A housing as described herein, for example, may have seven openings, each receiving a dual insert molded lead assembly, as shown in FIGS. 3H and 31. Two additional spaces receiving single insert molded lead assemblies may be provided at the ends of the connector. Housings for such a connector may have skeletal structures as illustrated in FIGS. 3F and 3G.

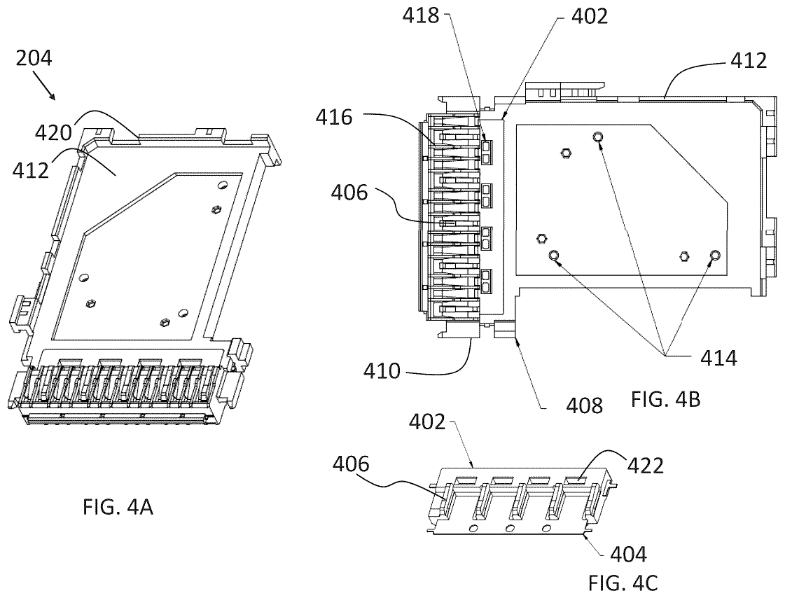

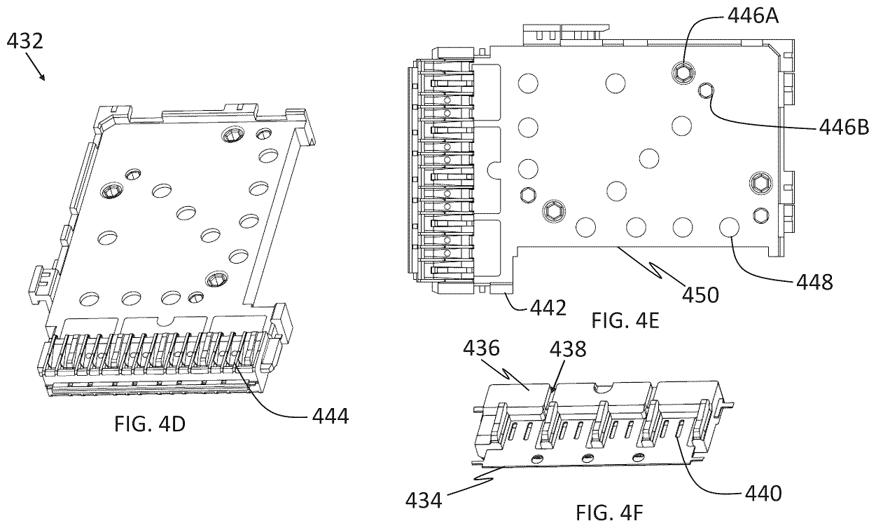

FIGS. 4A-4B depict a core member 204, according to some embodiments.

In the illustrated embodiment, core member 204 is made of three components: a metal shield, lossy material and insulative material. FIG. 4C depicts an intermediate state of the core member 204, which is after a first shot of lossy material and before a second shot of insulative material, according to some embodiments.

In some embodiments, the core member 204 may be formed by a two-shot process. In a first shot, lossy material 402 may be selectively molded over a T-Top interface shield 404. The lossy material 402 may form ribs 406 configured to provide connection between the ground conductive elements in the lead assemblies attached to the core member by, for example, physically contacting the ground conductive elements as illustrated in FIG. 5E. In conventional connectors without the core members, the housings are made by molding insulative material, without thin features of lossy material such as the ribs 406. The lossy material 402 may include slots 418, by which portions of the interface shield 404 may be exposed. This configuration may enable shields within the lead assemblies to be connected to the interface shield 404, such as by beams passing through the slots 418.

In a second shot, insulative material 408 may be selectively molded over the lossy material 402 and T-Top interface shield 404, forming a T-Top region 410 of the core member. The T-Top region 410 may be configured to hold the mating portions of the conductive elements of lead assemblies. The insulative material of the T-Top region may provide isolation between signal conductive elements of the lead assemblies and also mechanical support for the conductive elements by, for example, forming ribs 416.

In some embodiments, the shot for the lossy material 402 may be completed in multiple shots (e.g., 2 shots) for higher reliability in filling the mold. Similarly, the shot for the insulative material 408 may be completed in multiple shots (e.g., 2 shots).

The components of the T-Top assembly may be configured for simple and low cost molding. In conventional connectors without the core members, the mating interface portion of the connector includes a housing molded with walls between mating contact portions of conductive elements that are intended to be electrically separate. Other fine details, such as a preload shelf might similarly be molded in the housing to support proper operation of the connector when IMLAs are inserted into the housing. The ease with which such features can reliably be molded depends, at least in part, on the size and shape of the features as well as their location relative to other features in the part to be molded. The shape of a molded part is defined by recesses and projections on the interior surfaces of mold halves that are closed to encircle a cavity in which the molded part is formed. The part is formed by injecting molding material, such as molten plastic, into the cavity. During molding, the molding material is intended to flow throughout the cavity, so as to fill the cavity and create a molded part in the shape of the cavity. Features that are formed in portions of the mold cavity that molding material can reach only after flowing through relatively narrow passages are difficult to reliably fill, as there is a possibility that insufficient molding material will flow into those sections of the mold. That possibility might be avoided by using higher pressure during molding or creating more inlets into the mold cavity into which molding material can be injected. However, such counter measures increase the complexity of the molding process, and may still leave an unacceptable risk of defective parts.

Further, it is desirable in a molding operation for the molded part to be easily released from the mold when the mold halves are opened. Features in a molded part formed by projections or recesses that extend parallel to the direction in which the molded halves move when opened or closed can move, unobstructed by the molded part, when the mold opens.

In contrast, features formed by portions of the mold that project in an orthogonal direction contribute to added complexity, because those projections are inside an opening, or coring, of the molded part at the end of the molding operation. To remove the molded part from the mold, those projecting portions of the mold might be retracted. Molding operations can be performed with retractable projections, but retractable projections increase the cost of a mold. Thus, the cost and/or complexity of molding a connector housing may depend on the direction in which corings extend into the molded part with respect to the direction in which the mold halves move when opened or closed.

The inventors have recognized and appreciated connector designs that simplify the molding operation, reducing cost and manufacturing defects. In the embodiment illustrated, the mating interface is more simply formed using a combination of features in front housing 300 and core members 204, both of which may be shaped so as to avoid portions that are filled in a mold only through relatively long and narrow portions of the mold cavity.

For example, front housing 300 includes relatively large openings 312 housing the mating interface of the connector. Openings 312 are bounded by walls having relatively few features such that portions of the mold in which those walls are formed may be reliably filled in a molding operation. Further, housing 300 has features that can be formed by projections in a mold with halves that move in a direction perpendicular to the top and bottom orientations of FIGS. 3C and 3D. There may be few, if any, corings in locations that require moving parts in the mold.

Some fine features, including features that support reliable operation of the connector, may be formed in core members 204. While those features might increase molding complexity or have a risk of manufacturing defects if formed in a conventional connector housing, those features may be reliably formed in a simple molding operation. For example, the ribs 416, which extend outwards from a relatively large body portion 412 are easier to form than complex and thin sections inside a conventional connector housing.

Nonetheless, the ribs 416 may extend to a length that is sufficient for providing isolation between the mating contact portions of the adjacent conductive elements, but are not filled through relatively long and narrow passages in a mold cavity.

Moreover, these features are on an exterior surface of a part in a mold that opens or closes in a direction perpendicular to the surface of body 412. As can be seen in FIG. 4A, features such as ribs 416 and border 420 extend perpendicularly from the surface of body 412. In this way, the use of moving parts in the mold can be reduced or eliminated.

The insulative material 408 may extend beyond the T-Top region 410 to form a body 412 of the core member. The IMLAs may be attached to the body 412. The body 412 may include retention features 414 configured to secure the lead assemblies attached to the core member, such as posts that fit into holes in the IMLAs or holes that receive posts from the IMLAs.

The T-Top interface shield 404 may be made of metal or any other material that is fully or partially conductive and provides suitable mechanical properties for shields in an electrical connector. Phosphor-bronze, beryllium copper and other copper alloys are non-limiting examples of materials that may be used. The interface shields may be formed from such materials in any suitable way, including by stamping and/or forming.

In the embodiment illustrated, the shield 404 is molded over with lossy material and a second shot of insulative material is then over molded on that structure to form both the insulative portions of T-Top region 410 and body 412. When IMLAs are attached to core member 204, shield 404 is positioned adjacent the mating contact portions of the conductive elements of the IMLAs. For a dual IMLA assembly 202C, shield 404 is positioned between, and therefore adjacent, the mating contact portions of the signal conductors of both IMLAs attached to the core. Positioning shield 404 adjacent the mating contact portions and parallel to the column of mating contact portions may reduce degradation in signal integrity at the mating interface of the connector, such as by reducing cross talk from one column to the next and/or changes of impedance along the length of signal conductors at the mating interface. Lossy material electrically coupled to shield 404 may also reduce degradation of signal integrity.

Any suitable lossy material may be used for the lossy material 402 of the T-Top region 410 and other structures that are “lossy” (e.g., lossy member 1516). Materials that dissipate a sufficient portion of the electromagnetic energy interacting with that material to appreciably impact the performance of a connector may be regarded as lossy. A meaningful impact results from attenuation over a frequency range of interest for a connector. In some configurations, lossy material may suppress resonances within ground structures of the connector and the frequency range of interest may include the natural frequency of the resonant structure, without the lossy material in place. In other configurations, the frequency range of interest may be all or part of the operating frequency range of the connector.

For testing whether a material is lossy, the material may be tested over a frequency range that may be smaller than or different from the frequency range of interest of the connector in which the material is used. For example, the test frequency range may extend from 10 GHz to 25 GHz or 1 GHz to 5 GHz. Alternatively, lossy material may be identified from measurements made at a single frequency, such as 10 GHz or 15 GHz.

Loss may result from interaction of an electric field component of electromagnetic energy with the material, in which case the material may be termed electrically lossy. Alternatively or additionally, loss may result from interaction of a magnetic field component of the electromagnetic energy with the material, in which case the material may be termed magnetically lossy.

Electrically lossy materials can be formed from lossy dielectric and/or poorly conductive materials. Electrically lossy material can be formed from material traditionally regarded as dielectric materials, such as those that have an electric loss tangent greater than approximately 0.01, greater than 0.05, or between 0.01 and 0.2 in the frequency range of interest. The “electric loss tangent” is the ratio of the imaginary part to the real part of the complex electrical permittivity of the material.

Electrically lossy materials can also be formed from materials that are generally thought of as conductors, but are relatively poor conductors over the frequency range of interest. These materials may conduct, but with some loss, over the frequency range of interest such that the material conducts more poorly than a conductor of an electrical connector, but better than an insulator used in the connector. Such materials may contain conductive particles or regions that are sufficiently dispersed that they do not provide high conductivity or otherwise are prepared with properties that lead to a relatively weak bulk conductivity compared to a good conductor such as pure copper over the frequency range of interest. Die cast metals or poorly conductive metal alloys, for example, may provide sufficient loss in some configurations.

Electrically lossy materials of this type typically have a bulk conductivity of about 1 Siemen/meter to about 100,000 Siemens/meter, or about 1 Siemen/meter to about 30,000 Siemens/meter, or 1 Siemen/meter to about 10,000 Siemens/meter. In some embodiments, material with a bulk conductivity of between about 1 Siemens/meter and about 500 Siemens/meter may be used. As a specific example, material with a conductivity between about 50 Siemens/meter and 300 Siemens/meter may be used. However, it should be appreciated that the conductivity of the material may be selected empirically or through electrical simulation using known simulation tools to determine a conductivity that provides suitable signal integrity (SI) characteristics in a connector. The measured or simulated SI characteristics may be, for example, low cross talk in combination with a low signal path attenuation or insertion loss, or a low insertion loss deviation as a function of frequency.

It should also be appreciated that a lossy member need not have uniform properties over its entire volume. A lossy member, for example, may have an insulative skin or a conductive core, for example. A member may be identified as lossy if its properties on average in the regions that interact with electromagnetic energy sufficiently attenuate the electromagnetic energy.

In some embodiments, lossy material is formed by adding to a binder a filler that contains particles. In such an embodiment, a lossy member may be formed by molding or otherwise shaping the binder with filler into a desired form. The lossy material may be molded over and/or through openings in conductors, which may be ground conductors or shields of the connector. Molding lossy material over or through openings in a conductor may ensure intimate contact between the lossy material and the conductor, which may reduce the possibility that the conductor will support a resonance at a frequency of interest. This intimate contact may, but need not, result in an Ohmic contact between the lossy material and the conductor.

Alternatively or additionally, the lossy material may be molded over or injected into insulative material, or vice versa, such as in a two shot molding operation. The lossy material may press against or be positioned sufficiently near a ground conductor that there is appreciable coupling to a ground conductor. Intimate contact is not a requirement for electrical coupling between lossy material and a conductor, as sufficient electrical coupling, such as capacitive coupling, between a lossy member and a conductor may yield the desired result. For example, in some scenarios, 100 pF of coupling between a lossy member and a ground conductor may provide an appreciable impact on the suppression of resonance in the ground conductor. In other examples with frequencies in the range of approximately 10 GHz or higher, a reduction in the amount of electromagnetic energy in a conductor may be provided by sufficient capacitive coupling between a lossy material and the conductor with a mutual capacitance of at least about 0.005 pF, such as in a range between about 0.01 pF to about 100 pF, between about 0.01 pF to about 10 pF, or between about 0.01 pF to about 1 pF. To determine whether lossy material is coupled to a conductor, coupling may be measured at a test frequency, such as 15 GHz or over a test range, such as 10 GHz to 25 GHz.

To form an electrically lossy material, the filler may be conductive particles. Examples of conductive particles that may be used as a filler to form an electrically lossy material include carbon or graphite formed as fibers, flakes, nanoparticles, or other types of particles. Various forms of fiber, in woven or non-woven form, coated or non-coated may be used. Non-woven carbon fiber is one suitable material. Metal in the form of powder, flakes, fibers or other particles may also be used to provide suitable electrically lossy properties. Alternatively, combinations of fillers may be used. For example, metal plated carbon particles may be used. Silver and nickel are suitable metal plating for fibers. Coated particles may be used alone or in combination with other fillers, such as carbon flake.

Preferably, the fillers will be present in a sufficient volume percentage to allow conducting paths to be created from particle to particle. For example, when metal fiber is used, the fiber may be present in about 3% to 30% by volume. The amount of filler may impact the conducting properties of the material, and the volume percentage of filler may be lower in this range to provide sufficient loss.

The binder or matrix may be any material that will set, cure, or can otherwise be used to position the filler material. In some embodiments, the binder may be a thermoplastic material traditionally used in the manufacture of electrical connectors to facilitate the molding of the electrically lossy material into the desired shapes and locations as part of the manufacture of the electrical connector. Examples of such materials include liquid crystal polymer (LCP) and nylon. However, many alternative forms of binder materials may be used. Curable materials, such as epoxies, may serve as a binder. Alternatively, materials such as thermosetting resins or adhesives may be used.

While the above-described binder materials may be used to create an electrically lossy material by forming a binder around conducting particle fillers, lossy materials may be formed with other binders or in other ways. In some examples, conducting particles may be impregnated into a formed matrix material or may be coated onto a formed matrix material, such as by applying a conductive coating to a plastic component or a metal component. As used herein, the term “binder” encompasses a material that encapsulates the filler, is impregnated with the filler or otherwise serves as a substrate to hold the filler.

Magnetically lossy material can be formed, for example, from materials traditionally regarded as ferromagnetic materials, such as those that have a magnetic loss tangent greater than approximately 0.05 in the frequency range of interest. The “magnetic loss tangent” is the ratio of the imaginary part to the real part of the complex electrical permeability of the material. Materials with higher loss tangents may also be used.

In some embodiments, a magnetically lossy material may be formed of a binder or matrix material filled with particles that provide that layer with magnetically lossy characteristics. The magnetically lossy particles may be in any convenient form, such as flakes or fibers. Ferrites are common magnetically lossy materials. Materials such as magnesium ferrite, nickel ferrite, lithium ferrite, yttrium garnet or aluminum garnet may be used. Ferrites will generally have a loss tangent above 0.1 at the frequency range of interest. Presently preferred ferrite materials have a loss tangent between approximately 0.1 and 1.0 over the frequency range of 1 GHz to 3 GHZ and more preferably a magnetic loss tangent above 0.5 over that frequency range.

Practical magnetically lossy materials or mixtures containing magnetically lossy materials may also exhibit useful amounts of dielectric loss or conductive loss effects over portions of the frequency range of interest. Suitable materials may be formed by adding fillers that produce magnetic loss to a binder, similar to the way that electrically lossy materials may be formed, as described above.

It is possible that a material may simultaneously be a lossy dielectric or a lossy conductor and a magnetically lossy material. Such materials may be formed, for example, by using magnetically lossy fillers that are partially conductive or by using a combination of magnetically lossy and electrically lossy fillers.

Lossy portions also may be formed in a number of ways. In some examples the binder material, with fillers, may be molded into a desired shape and then set in that shape. In other examples the binder material may be formed into a sheet or other shape, from which a lossy member of a desired shape may be cut. In some embodiments, a lossy portion may be formed by interleaving layers of lossy and conductive material such as metal foil. These layers may be rigidly attached to one another, such as through the use of epoxy or other adhesive, or may be held together in any other suitable way. The layers may be of the desired shape before being secured to one another or may be stamped or otherwise shaped after they are held together. As a further alternative, lossy portions may be formed by plating plastic or other insulative material with a lossy coating, such as a diffuse metal coating.

FIGS. 4D-4F depict another embodiment of a core member. FIG. 4D is a perspective view of a core member 432. FIG. 4E is a side view of the core member 432. FIG. 4F is a perspective view of the core member 432 after a first shot of lossy material and before a second shot of insulative material. The core member 432 may include a T-Top interface shield 434 having through holes 440, lossy material 436 selectively molded over the T-Top interface shield 434, and insulative material 442 molded over exposed portions of the T-Top interface shield 434 and forming a body 450. Portions of the lossy material 436 may be separated by gaps 438, from which the T-Top interface shield 434 may be exposed. The insulative material 442 may be molded over areas of the T-Top interface shield 434 that are exposed, fill the through holes 440 and form ribs 444. The insulative material 442 may fill the gaps 438 between the portions of the lossy material 436 so as to provide mechanical strength between the body 450 of the core member and the T-Top interface shield 434. As the body 412 illustrated in FIG. 4B, the body 450 may include retention features 446A for a Type-A IMLA and retention features 446B for a Type-B IMLA. Additionally, the body 450 may include openings 448, which may be sized and positioned according to openings 452 of shields 502 (See, e.g., FIG. 5N). The openings 448 may enable electrical connections between the shields 502 of the Type-A and Type-B IMLAs attached to the core member 432. Fully or partially electrically conductive members may pass through the openings to make such connections. For example, the openings may be filled with lossy material. As another example, conductive fingers from the shields 502 may pass through the openings. Such configuration may reduce crosstalk, for example, between IMLAs.

FIGS. 5A-5D depict a dual IMLA assembly 202C, according to some embodiments. The dual IMLA assembly 202C may include a core member 204. A type-A IMLA 206A may be attached to one side of the core member 204. A Type-B IMLA 206B may be attached to the other side of the core member 204. Each IMLA may include a column of conductive elements shaped and positioned for signal and ground, respectively. In the illustrated example, ground conductive elements are wider than signal conductive elements. The mating contact portions of the ground conductive elements may include openings 530 shaped and positioned to provide a mating force approximating that of the mating contact portions of the signal conductive elements. The ribs 406 of the lossy material 402 of the core member 204 may be positioned such that, when the IMLA is attached to the core member, the ground conductive elements of the IMLA are electrically coupled to the lossy material 402 through ribs 406. In some operating states, the ground conductive elements may press against the ribs 406 and/or may be close enough to capacitively couple to them.

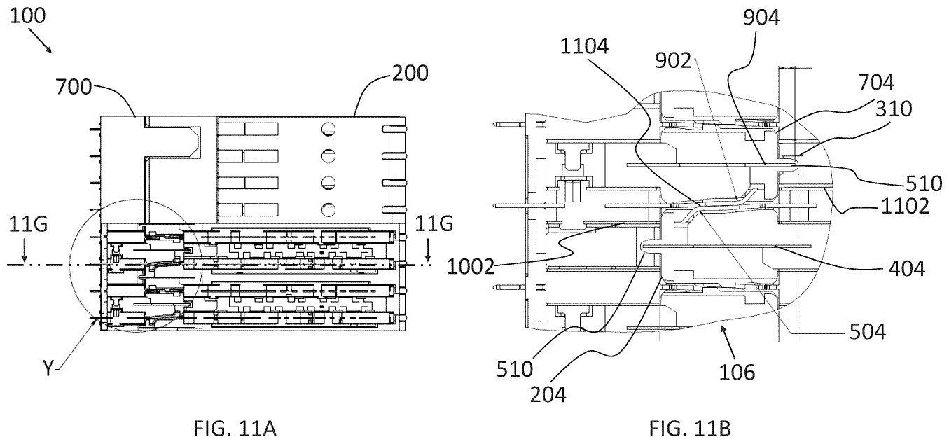

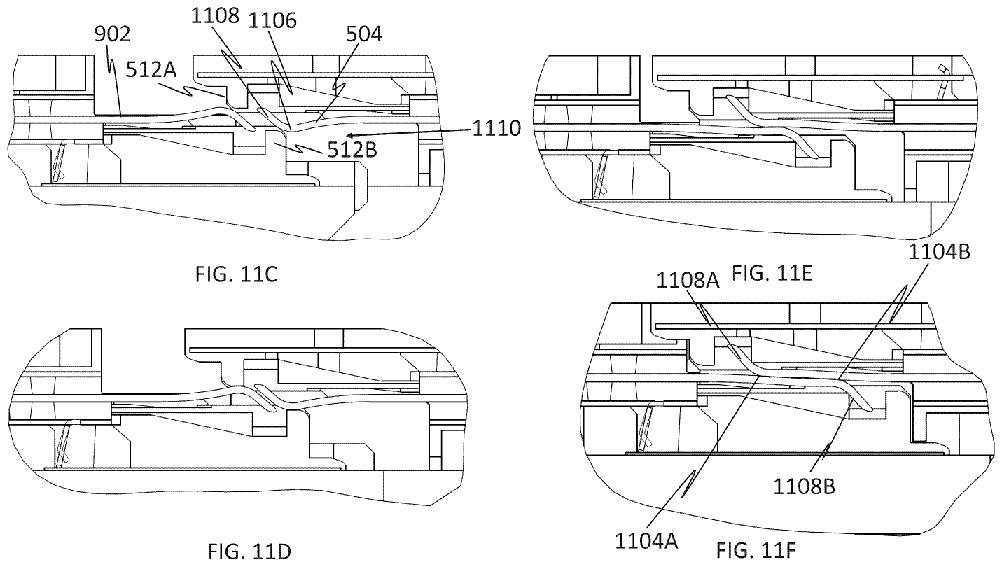

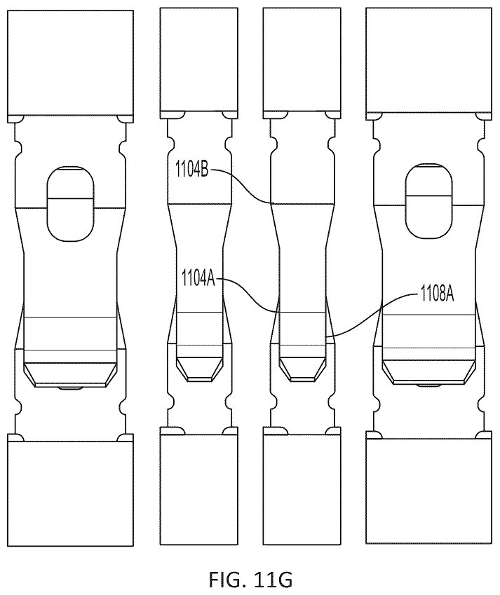

The T-Top interface shield 404 of the core member 204 may include an extension 510. The extension 510 may extend beyond the mating face 536 of the IMLA such that the extension 510 of the interface shield 404 may extend into a mating connector. Such a configuration may enable the interface shield 404 to overlap internal shields of a mating connector as illustrated in an exemplary embodiment of FIGS. 11A-11B. The extension 510 of the interface shield 404 may be molded over with the insulative material 408 by a thickness t1, which may be smaller than a thickness t2 of the insulative material over molding the body of the T-Top region 410. In some embodiments, the thickness t1 may be less than 20% of the thickness 12, or less than 15%, or less than 10%.

In addition to extending a ground reference provided by shield 404 through the mating interface, a relatively thin extension 510 may contribute to mechanical robustness of the interconnection system. This configuration allows inserting the extension 510 of the interface shield into a matching slot in a housing of a mating connector, which may be formed with only a small impact on the mechanical structure of the housing of the mating connector. In the illustrated embodiment, the mating connectors have similar mating interfaces. Accordingly, front housing 300 of connector 200 (FIG. 3A), illustrates certain features that are also present in a mating connector, e.g., the header connector 700. One such feature is slots 310 configured to receive the extensions 510 at the distal ends of the T-Top regions.

If the core member 204 did not have this extension 510, but a substantially uniform thickness in a shape of, for example, a rectangle at the distal end, a receiving housing wall of the mating connector would be reduced to accommodate the extension 510, which would reduce the robustness of the mechanical structure of the connector housing.

FIG. 5E depicts a front view of the dual IMLA assembly 202C, partially cut away, according to some embodiments. As can be seen in the cutaway section, ribs 406 of lossy material 402 extend towards certain ones of the mating contact portions in each column. Those mating contact portions may be of the ground conductive elements. Here, the lossy material 402 is shown to occupy a continuous volume, but in other embodiments, the lossy material may be in discontinuous regions. For example, the lossy material 402 on one side of the shield 404 may be physically disconnected from the lossy material 402 on the other side of the shield.

FIG. 5F depicts a cross-sectional view along line P-P in FIG. 5D, illustrating the Type A IMLA coupled to the Type-B IMLA through the core member 204 (FIG. 4A), according to some embodiments. FIG. 5F reveals that, in the illustrated embodiment, each IMLA has a shield 502 with, in this example, a planar body parallel to the intermediate portions of the conductive elements serving as signal conductors or ground conductors through the IMLA. Shield 404 is parallel to the mating contact portions of the conductive elements. Shields 404 and 502 may be electrically connected.

FIG. 5G shows features for connecting shields 404 and 502 in an enlarged view of the circle marked as “B” in FIG. 5F, according to some embodiments. This region encompasses openings 422 (see also, FIG. 4C) in the lossy portion of the core member 204, through which portions of the shields 404 are exposed. The exposed portions of the shields 404 include features to connect to shields 502. Here, those features are slots 418. Shields 502 may be stamped from a sheet of metal and may be stamped with structures, such beams 506, which may be inserted into slots 418 when the IMLA is pressed onto core member 204 so as to electrically connect shields 404 and 502.

FIG. 5H depicts a cross-sectional view along ling P-P in FIG. 5D, illustrating the Type A IMLA coupled to the Type-B IMLA through the core member 432 (FIG. 4D), according to some embodiments. As illustrated, in some embodiments, the T-Top may be configured without T-Top shield slots 418. Omitting the slots 418 may enable a connector to have a smaller pitch, such as less than 3 mm, and may be approximately 2 mm, for example.

In some embodiments, the features for connecting the shields may also be simply formed. For example, openings 422 are extend in a direction perpendicular to the surface of body portion 412 and may be molded without moving portions of the mold. Also, a preload feature 512 is shown, also extending in a direction perpendicular to the surface of body portion 412.

Likewise, core member 204 may be molded with an opening 508. The opening 508 may be configured to receive the beam tips of conductive elements when an IMLA is mounted to the core member 204. The opening 508 enables the beam tips to flex upon mating with a mating connector.

In some embodiments, the core member 204 may include pre-load features 512 configured to preload conductive elements of a mating connector. The pre-load features may be positioned beyond the distal end of a tip 532 of a conductive element of the IMLA. In this configuration, the pre-load feature may touch a conductive element of a mating connector before the conductive element reaching the tip 532. For example, upon mating, a first connector including the IMLA assembly of FIG. 5F with a second connector having a similar mating interface, the pre-load features 512 of the first connector may engage tips 532 of the second connector and press them into opening 508. Thus, the tips 532 of the second connector are pressed out of the path of the first connector, which reduces the chance of stubbing. When the mating interfaces of the first and second connector are similar, the tips 532 of the first connector are pressed out of the path of the second connector by pre-load features 512 of the second connector.

The pre-load features illustrated in FIG. 5F differ from a pre-load shelf in conventional connectors in which the beam tips of the conductive element are restrained, in a partially deflected state, by pre-load features of the same connector. Such a design, for example, may involve a pre-load shelf on which a portion of the beam tip rests. In that configuration a portion of the tip extends far enough onto the pre-load shelf to be reliably held in place.

Such a configuration entails a segment of the conductive element between the convex contract point for each conductive element and the distal-most tip of the conductive element. That segment of the conductive element is out of the desired signal path and can constitute an un-terminated stub, which may undesirably impact the integrity of signals propagating along the conductive elements. The frequency of that impact may be inversely related to the length of the stub such that shortening the stub enables high frequency connector operation. Unterminated stubs on ground conductive elements may similarly impact signal integrity.

In the illustrated embodiment, however, the tip of the conductive elements is unrestrained. The segment between the convex contract point 536 and the distal end of tip 532 does not have to be sufficiently long to engage a pre-load shelf. This design enables reducing the length of the tips of conductive elements, without increasing the risk of stubbing upon mating. In some embodiments, the distance between the convex contact location and the tip of the conductive elements may be in the range of 0.02 mm and 2 mm and any suitable value in between, or in the range of 0.1 mm and 1 mm and any suitable value in between, or less than 0.3 mm, or less than 0.2 mm, or less than 0.1 mm. A method of operating connectors with such pre-load features to mate with each other is described with respect to FIGS. 11A-11F.

Forming these features as part of the core members enables miniaturization of the connector, as these features will have dimensions that are proportional to the dimensions of the conductive elements and the spacing between them. However, as these features are formed in the core member, rather than as a thin, complex geometry if integrally formed with the front housing 300, they may be more reliably formed. These features may be used in a high speed, high density connector in which signal conductive elements are spaced (center-to-center) from each other by less than 2 mm, or less than 1 mm, or less than 0.75 mm in some embodiments, such as in the range of 0.5 mm to 1.0 mm, or any suitable value in between. Pairs of signal conductive elements may be spaced (center-to-center) from each other by less than 6 mm, or less than 3 mm, or less than 1.5 mm in some embodiments, such as in the range of 1.5 mm to 3.0 mm, or any suitable value in between.

In some embodiments, a lead assembly may include IMLA shield 502, extending in parallel to a column of conductive elements 504. The IMLA shield 502 may include a beam 506 extending in a direction substantially perpendicular to the plane along which the IMLA shield extends. The beam 506 may be inserted in an opening 422 and contact a portion of the T-Top interface shield 404, such as by being inserted into a shield slot 418. In the illustrated example, the IMLA shield 502 of the Type-A IMLA is electrically coupled to an IMLA shield of the Type-B IMLA through the lossy material 402 and the interface shield 404 of the core member 204.

FIG. 5I is a perspective view of the Type-A IMLA 206A, according to some embodiments. In the illustrated example, the Type-A IMLA 206A includes leads 514 sandwiched between ground plates 502A and 502B. The leads 514 may be selectively overmolded with dielectric material 546 before the ground plates 502A and 502B are attached. FIG. 5N is an exploded view of the Type-A IMLA 206A, with dielectric material 546 removed, according to some embodiments. FIG. 5O is a partial cross-sectional view of the Type-A IMLA 206A of FIG. 5N, according to some embodiments. FIG. 5P is a plan view of the Type-A IMLA 206A, with ground plates 502A and 502B removed and showing the dielectric material 546, according to some embodiments.

The leads 514 may include a column of signal conductive elements. The signal conductive elements may include single-ended signal conductive element 208A and differential signal pairs 208B, which may be separated by ground conductive elements 212. In some embodiments, the conductive element 208A may be used for purposes other than passing differential signals, including passing, for example, low speed or low frequency signal, power, ground, or any suitable signals.

Shielding substantially surrounding the differential signal pairs 208B may be formed by the ground conductive elements together with the ground plates 502A, 502B. As illustrated, the ground conductive elements 212 may be wider than the signal conductive elements 208A, 208B. The ground conductive elements 212 may include openings 212H. In some embodiments, the lead 514s may be selectively over molded with insulative material, which may substantially over mold intermediate portions of the signal conductive elements. The ground plates 502A, 502B may be attached to the over molded leads 514.

In some embodiments, the lead assembly may include lossy material that contacts and electrically connects the ground plates and the ground conductors. In some embodiments, lossy material may extend through openings 212H in the ground conductors and/or through openings 452 of ground plates 502A and 502B to make electrical contact. In some embodiments, this configuration may be achieved by molding a second shot of lossy material after the ground plates are attached. For example, lossy material may fill at least portions of the openings 212H through the openings 452 of the ground plates 502A, 502B so as to electrically connect the ground conductive elements 212 with the ground plates 502A, 502B and seal the gap between them caused by the insulative lead overmold. The openings 212H of the ground conductive elements 212 and the openings 452 of the ground plates 502A, 502B may be shaped to increase tolerance for filling the lossy material. For example, as illustrated in FIG. 5N, the openings 212H of the ground conductive elements 212 may have an elongated shape compared to the openings 452 that are substantially circles. Alternatively or additionally, the lossy material may be molded over the lead assembly, with hubs at the surface. Ground plates 502A, 502B may be attached by pressing the hubs through openings 452.

The ground plates 502A and 502B may provide shielding for intermediate portions of the conductive elements on two sides. The ground plate 502A may be configured to face the core member 204, for example, including features to attach to the core member 204. The ground plate 502B may be configured to face away from the core member 204. The shielding provided by the ground plates 502A and 502B may connect to shielding provided by interface shielding interconnects 214 and mating interface shielding provided by the T-Top that the lead is attached to and another T-Top of a mating connector, for example, as illustrated in FIG. 11B. Such configuration enables high frequency performance by shielding throughout two mated connectors.

The ground plates and/or the dielectric portions may include openings configured to receive retention features of the core member (e.g., retention features 414). It should be appreciated that, though the Type-B IMLA 206B has a different configuration of signal and ground conductors than in a Type-A IMLA, it may similarly be configured with ground plates and retention features similar to the Type-A IMLA 206A.

Each type of IMLA may include structures that connect the ground plates to ground structures on a printed circuit board to which a connector, formed with those IMLAs, is mounted. For example, the Type-A IMLA 206A may include compressible members 518, which may form portions of the mounting interface shielding interconnect 214 (FIG. 2C). In some embodiments, the compressible members 518 may be formed integrally with the ground plates 502A and 502B. For example, the compressible members 518 may be formed by stamping and bending a metal sheet that forms a ground plate. The integrally formed shielding interconnect simplifies the manufacturing process and reduces manufacturing cost.

In some embodiments, the shielding interconnect 214 may be formed to support a small connector footprint. The shielding interconnect, for example, may be designed to deform when pressed against a surface of a printed circuit board, so as to generate a relatively small counterforce. The counterforce may be sufficiently small that press fit contact tails, as illustrated in FIG. 5I, may adequately retain the connector against that counterforce. Such a configuration reduces connector footprint because it avoids the need for retaining features such as screws.

Enlarged views of a shielding interconnect 214 implemented with compressible members 518 are illustrated in FIGS. 5J-5M. FIG. 5J and FIG. 5K depict enlarged perspective views of a portion 516 of the Type-A IMLA 206A within the circle marked as “5J” in FIG. 5I, according to some embodiments. FIG. 5L and FIG. 5M depict a perspective view and a plan view, respectively, of the portion 516 of the Type-A IMLA 206A with the organizer 210 attached, according to some embodiments. The portion 516 of the Type-A IMLA 206A with the organizer 210 attached is also illustrated in FIG. 2C within the circle marked as “5L.” FIGS. 5K and 5L show views taken through the neck of a press fit contact tail. The distal, compliant portion of the contact tail, shown as an eye-of-the-needle segment in FIG. 5J, may be present. Though, the contact tails may be in configurations other than eye-of-the-needle press-fits.

The shielding interconnect 214 may fill a space between the connector and the board, and provide current paths between the board's ground plane and the connector's internal ground structures such as the ground plates. In some embodiments, a pair of differential signal conductive elements (e.g., 208B) may be partially surrounded by shielding interconnects 214 extending from ground plates that sandwich the lead having the pair. The contact tails of the pair may be separated from the shielding interconnect 214 by dielectric material of the organizer 210.

In some embodiments, a shielding interconnect 214 may include a body 562 extending from an edge of an IMLA shield. One or more gaps 528 may be cut in body 562, creating a cantilevered compressible member 518. A distal portion of the compressible member 518 may be shaped with a tine 520. When the connector is pushed onto a board, the tines 520 may make physical contact with the board, causing deflection of compressible member 518. Compressible member 518 is cantilevered and could, in some embodiments, act as a compliant beam. In the embodiment illustrated, however, deflection of compressible member 518 generates a relatively low spring force. In this embodiment, gap 528 includes an enlarged opening 568 at the base of compressible member 518 configured to weaken the spring forces by making the compressible members 518 easier to deflect and/or deform. A low spring force may prevent the tines from springing back when contacting a board such that the connector would not be pushed off the board. The resulting spring force, per tine, may be in the range of 0.1 N to 10N, or any suitable value in between, in some embodiments. The compressible members may or may not make physical contact with a board. In some embodiments, the compressible members may be adjacent the board, which may provide sufficient coupling to suppress the emissions at the mounting interface.

In some embodiments, a body 562 and compressible member 518 may include an in-column portion 522 extending from a ground plate (e.g., 502A or 502B), a distal portion 526 substantially perpendicular to the in-column portion 522, and a transition portion 524 between the in-column portion 522 and the distal portion 526. Such a configuration enables the shielding interconnects 214 extending from two adjacent shields to cooperate to surround, at least in part, contact tails of a pair of signal conductive elements. For example, four shielding interconnects 214 may surround a pair, as shown, two extending from each IMLA shield on each side of the signal conductive elements, one on each side of the pair.

In the illustrated, for example in FIG. 5L, there are gaps between the shielding interconnects. For examples, there are gaps 542 between the distal portion 526 of shielding interconnects 214 on opposite sides of a pair of signal conductors. There are also gaps 544 between the in-column portion 522 of shielding interconnects 214 on the same sides of a pair of signal conductors. Bridges 266 of the organizer 210 may at least partially occupy the gaps 542 and 544. Nonetheless, the illustrated configuration may be effective at reducing resonances in the ground structures of the connector over a desired operating range of the connector, such as up to 112 Gbps or higher.

In some embodiments, tines 520 on compressible member 518 may be selectively positioned so as to more effectively suppress resonances. The tines, 520, as they provide a path for high frequency ground return current to flow to or from the ground plane of the PCB provide a reference for electromagnetic waves. In the illustrated example, the tines 520 and therefore the location of the references are positioned where the electromagnetic fields around the pair of signal conductors partially surrounded by shielding interconnects 214 is high. In the illustrated example, the electromagnetic field around the pair of tails of signal conductors may be the strongest between pairs in a column, but offset from the centerline 216 of the column by an angle α in the range of 5 to 30 degrees, or 5 to 15 degrees, or any suitable number in between. Accordingly, tines 520 positioned in this location with respect to the tails of the signal conductors of each pair may be effective at reducing resonances and improving signal integrity.

In the illustrated example, the tines 520 extend from the distal portions 526. It should be appreciated that the present disclosure is not limited to the illustrated positions for the tines 520. In some embodiments, the tines 520 may be positioned, for example, extending from the in-column portions 522 or the transition portions 524. It also should be appreciated that the present disclosure is not limited to the illustrated number of the tines 520. A differential signal pair may be surrounded by four tines 520 as illustrated, or more than four tines in some embodiments, or less than four tines in some embodiments. Further, it should be appreciated that it may not be necessary for all tines to make physical contact with the ground plane of a mounting board. A tine may or may not make physical contact with a mounting board, for example, depending on the actual surface topology of the mounting board. For example, the times 520 may be positioned to make physical or capacitive contact with ground vias 244 in FIG. 2D.

A Type-B IMLA may similarly have compressible members positioned with respect to pairs of signal conductors as shown in FIGS. 5J and 5K. The arrangement of pairs within a column, however, may differ between a Type-A and a Type-B IMLA.

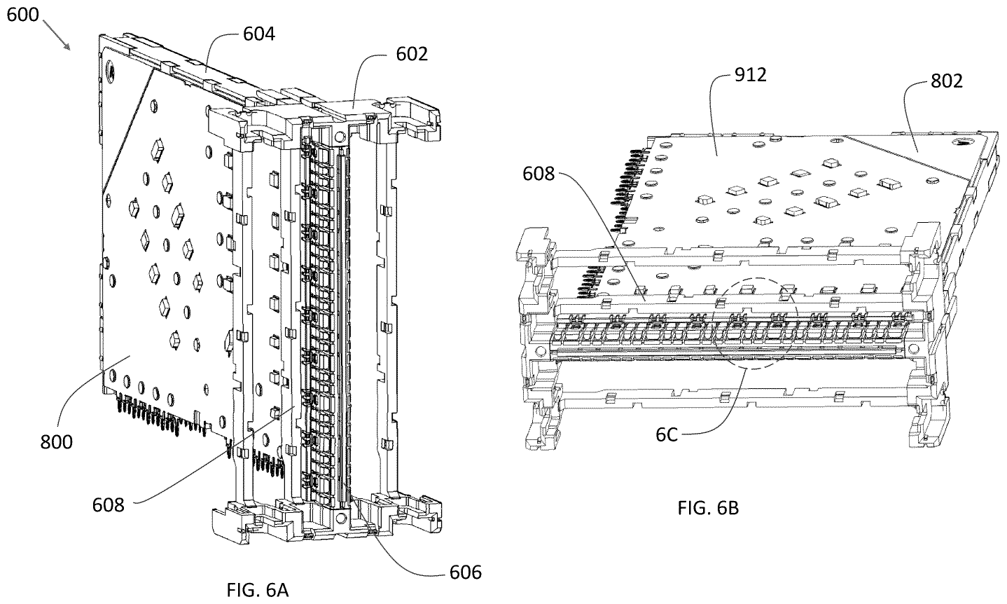

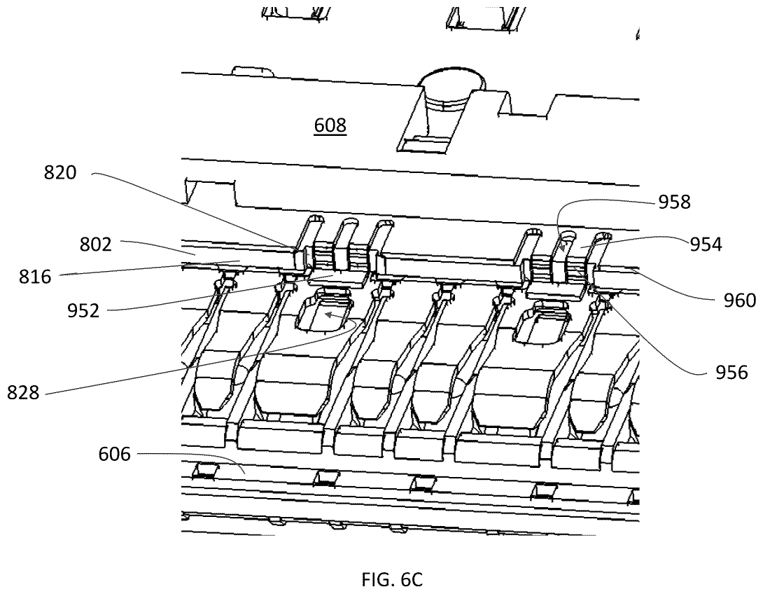

FIGS. 6A-C depict perspective views and enlarged view, respectively, of a right angle connector 600 with features that improve high frequency performance. Although the following descriptions may focus on some features of the right angle connector 600, it should be appreciated that the right angle connector 600 may have some or all of the features of the right angle connector 200, as described herein or features discussed in connection with connector 600 may be applied to other connectors described herein.

As illustrated, the right angle connector 600 may have a front housing 602 with walls that bound a mating interface region for the connector. In this example, front housing 6020 has inner walls 608 extending substantially in parallel to each other, and IMLA T-top assemblies 604 are inserted between adjacent inner walls 608 (a dual IMLA T-top assembly is shown and others hidden in the figures). Similar to the dual IMLA T-top assembly 202C of the right angle connector 200, the dual IMLA T-top assembly 604 may include a core member 606, and Type-A and Type-B IMLAs attached to opposite sides of the core member 606.

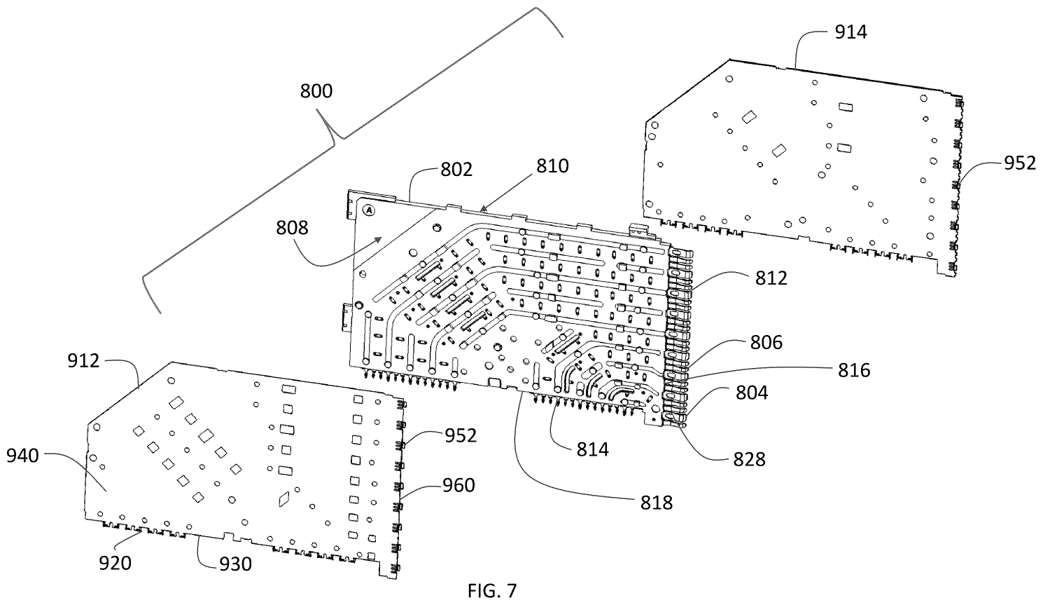

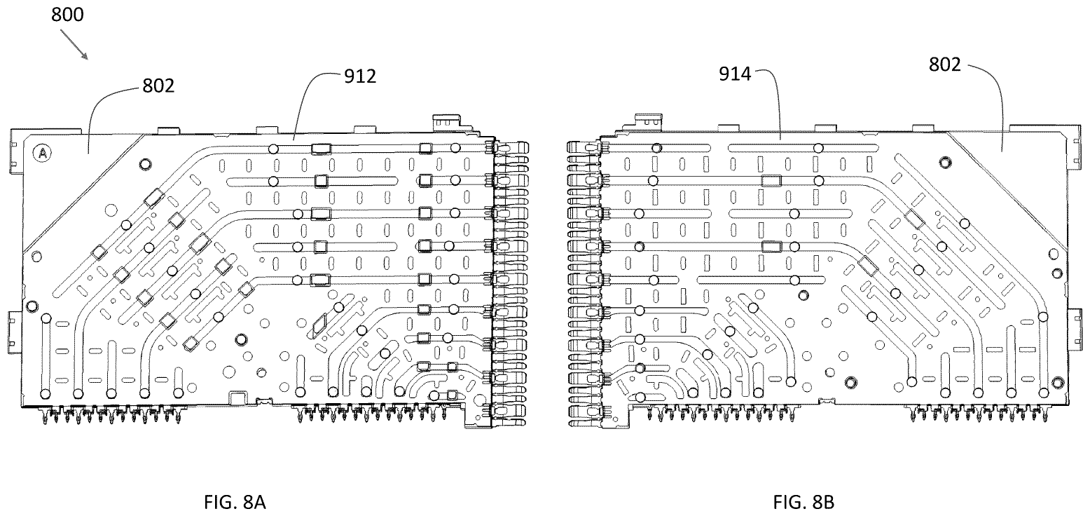

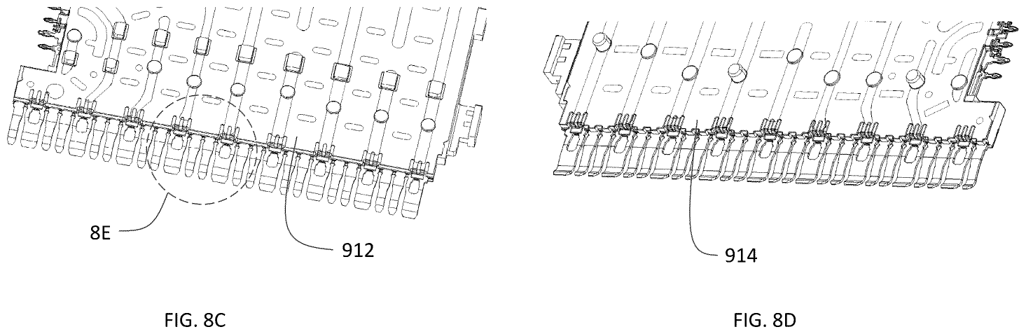

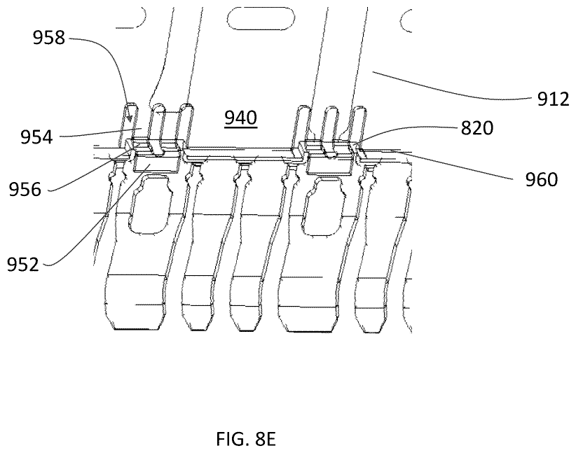

FIGS. 7-8B depict a partially exploded perspective view and side views, respectively, of a Type-A IMLA 800 of the dual IMLA assembly 604 of the right angle connector 600. It should be appreciated that a Type-B IMLA of the dual IMLA assembly 604 of the right angle connector 600 may have any suitable features of the Type-A IMLA 800 of the right angle connector 600 and/or any suitable features of the Type-B IMLA 206 of the right angle connector 200.

FIGS. 8C-8D are perspective views of opposing sides of the Type-A IMLA 800, showing mating ends of a column of conductive elements extending from the IMLA housing. FIG. 8E is an enlarged view of the portion designated 8E in FIG. 8C.

As illustrated, the Type-A IMLA 800 may include an assembly housing 802 having a mating edge 816 and a mounting edge 818 extending perpendicular to the mating edge 816, and conductive elements held by the assembly housing 802. Each conductive element may have a mating end 812 extending out of the mating edge 816 of the assembly housing 802, a mounting end 814 extending out of the mounting edge 818 of the assembly housing 802, and an intermediate portion (hidden in the assembly housing) joining the mating end 812 and the mounting end 814. For each lead assembly such as the Type-A IMLA 800, the assembly housing 802 may hold the mating ends 812 of the conductive elements in a first column and the mounting ends 814 of the conductive elements in a second column perpendicular to the first column.

The conductive elements may include ground conductors 804 disposed between signal conductors 806. The ground conductors 804 may be wider than signal conductors 806. The mating ends 812 of the ground conductors 804 may have openings 828 extending therethrough, which may be configured to adjust mating forces applied by the ground conductors.

The Type-A IMLA 800 may include a first shielding member 912 attached to a first side 808 of the assembly housing 802, and a second shielding member 914 attached to a second side 810 of the assembly housing 802. Each of the first and second shielding members 912 and 914 may include a body 940 disposed on respective sides 808 and 810 of the assembly housing 802, a mating edge 960 substantially aligned with the mating edge 816 of the assembly housing 802, a mounting edge 930 substantially aligned with the mounting edge 818 of the assembly housing 802, and tines 920 extending from the mounting edge 930. The tines 920 may be configured similar to the tines 520 of the right angle connector 200.

The inventors have recognized and appreciated that connecting the shielding members to the ground conductors at their mating ends can improve crosstalk over a wide frequency range. The connection may be both electrical and mechanical and may be achieved, for example, via welding, such as electrical resistance welding or laser welding. As illustrated, the first and second shielding members 912 and 914 may include first and second tabs 952, respectively. For each shielding member, the tabs 952 may be disposed in a column parallel to the first column of the mating ends 812 of the conductive elements and each be connected to a corresponding ground conductor 804.

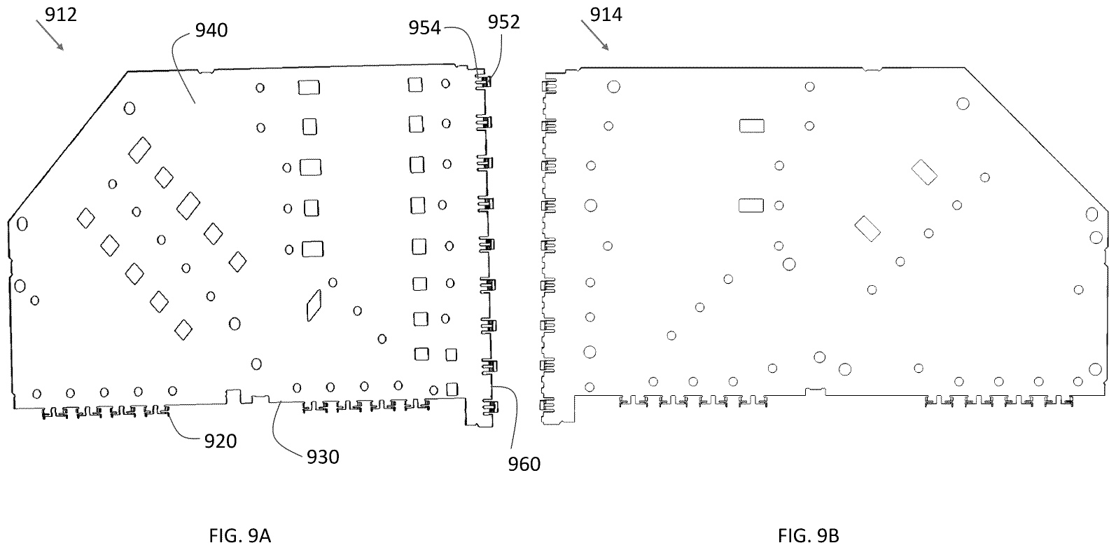

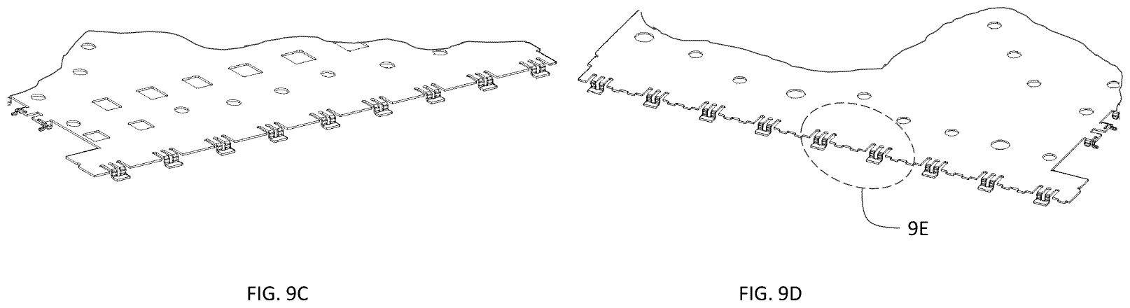

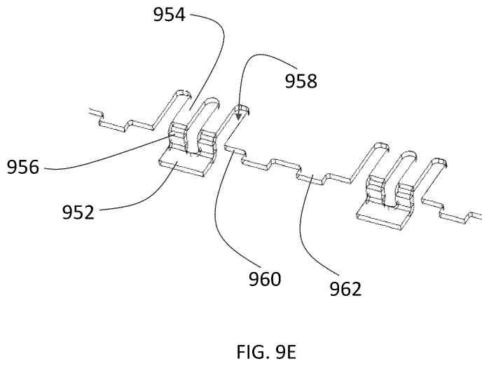

FIGS. 9A-B are side views of the first and second shielding members 912 and 914, respectively. FIGS. 9C-E depict enlarged views of portions of the first and second shielding members 912 and 914, respectively, showing the edges adjacent the mating interface. As illustrated, for each of the first and second shielding members 912 and 914, the body 940 may include beams 954 extending towards the mating edge 960, and slots 958 separating the beams 954 from each other or portions of the body 940. The beams 954 may be connected to respective tabs 952 through transition portions 956. Each transition portion 956 may extend perpendicular to both the respective beam 954 and the first column of mating ends 812. Each tab 952 may be connected to one or more beams. In the example illustrated, each tab 952 is connected to two beams 954 through two transition portions 956.

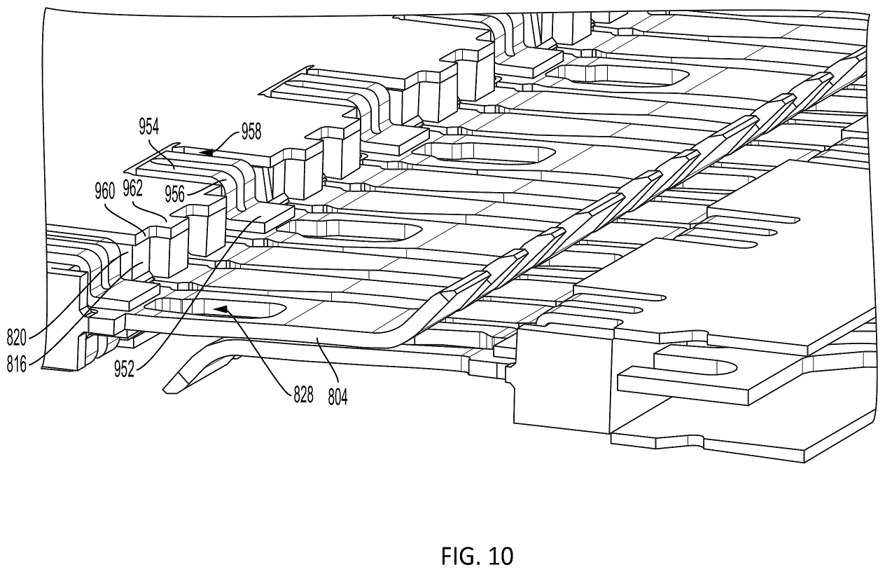

One or more of the shielding members may include tabs (e.g., tabs 962) disposed corresponding to the signal conductors 806. In the illustrated example, the second shielding member 914 includes tabs 962 disposed between the tabs 952 and separated from the mating ends 812 of respective signal conductors 806 by the assembly housing 802 (FIG. 10).

Referring back to FIG. 6C, for each of the ground conductors 804, a respective tab 952 may be disposed between the mating edge 816 of the assembly housing 802 and the opening 828 of the ground conductor 804. As illustrated, the mating edge 816 of the assembly housing 802 may have recesses 820 disposed corresponding to the ground conductors 804 and configured to receive portions of the tabs 952, which may enable the tabs 952 to have larger areas and therefore reduce contact resistance and improve manufacturing tolerances. The transition portions 956 may be disposed in respective recesses 820.

The inventors have recognized and appreciated that connecting each of the tabs through multiple beams 954 and transition portions 956 separated by slots 958 may further reduce crosstalk. In some embodiments, as illustrated in FIG. 6C, the beams 954 and slots 958 may extend at least to the respective inner walls 608 of the front housing 602. In such an embodiment, the beams may extend to or into the mating interface region for the connector as defined by walls of the front housing. In some embodiments, the beams 954 and slots 958 may at least partially overlap the interface shield 904 of a respective core member (see, e.g., FIGS. 11B, 11F).

FIG. 10 is an enlarged view of a mating interface region between two IMLAs of the connectors of the electrical interconnection system 100, according to some embodiments. In some embodiments, the mating interfaces of the two mating IMLAs may be in rotational symmetry. As illustrated, both mating IMLAs may have two shielding members, on top and bottom surface in the orientation illustrated in FIG. 10, either or both of which may be connected to the wider conductors, which in this example are designated as ground conductors. In this example, both shielding members are connected to mating ends of respective ground conductors. For each IMLA, each ground conductor 804 may have a portion sandwiched between the tabs 952 of the first and second shielding members. The first and second tabs may overlap with each other, which may enable the first and second tabs to be connected to the ground conductor at one time through, for example, resistance welding.

FIG. 11A depicts a top view of the electrical interconnection system 100, partially cut away, according to some embodiments. FIG. 11B depicts an enlarged view of the circle marked as “Y” in FIG. 11A, according to some embodiments. The techniques described in connection with FIGS. 11A-11G are illustrated as applied to a connector 200, but may be similarly applied to any connector as described herein, including connector 600.

In the illustrated example, the right angle connector 200 and the header connector 700 are mated by forming electrical connection between conductive elements 504 of the right angle connector 200 and conductive elements 902 of the header connector 400 at one or more contact locations 1104. FIG. 11B illustrates in cross section a portion of header connector 700 and a portion of the right angle connector 200 at which a conductive element from each of the connectors are mated. The conductive elements may be signal conductive elements or ground conductive elements, as, in the illustrated embodiment, both have the same profile in cross section.

In this configuration, mated portions of the conductive elements 504 and 902 are shielded by the T-Top interface shield 404 of the core member 204 of the right angle connector 200 and the T-Top interface shield 904 of the core member 704 of the header connector 700. In this way, the shielding configuration, with planar shields on both sides of the conductive elements, is carried into the mating interface of the mated connectors. However, rather than that two-sided shielding being provided by the IMLA shields 502 or 1002 as for the intermediate portions of the conductive elements within the IMLA insulation, the two-sided shielding is provided by the T-Top shields of the two T-Tops carrying the mating contact portion of the two mated conductive elements.

It also should be appreciated that the T-Top interface shield 404 of the core member 204 of the right angle connector 200 overlaps with the shield 1002 of the lead assembly 706 of the header connector 700 when the connectors are mated. The T-Top interface shield 904 of the core member 704 of the header connector 700 overlaps with the shield 1002 of the lead assembly 206 of the right angle connector 200 when the connectors are mated. A length of the overlaps may be controlled by a length of extensions of interface shields (e.g., extension 510 of the T-Top interface shield 404). The extension 510 may have a thickness smaller than the rest of the core member such that the extension 510 can be inserted into a matching opening of a mating connector. The above described configuration of T-Top interface shields 404 and 904 of the core members 204 and 704 not only provides shielding for the mated portions of the conductive elements at the mating interface 106 but also reduces shielding discontinuity caused by the change from the internal shields of lead assemblies (e.g., shields 1002, 1102) to the interface shields (e.g., T-Top interface shields 404, 904).

A method of operating connectors 200 and 700 to mate with each other in accordance with some embodiments is described herein. Such a method may enable conductive elements to have short lead-in segments between a contact point and distal end, which enhances high frequency performance. Yet, there may be a low risk of stubbing. FIGS. 11C-11F depict enlarged views of the mating interface of the two connectors of FIG. 1A, or connectors in other configurations with similar mating interfaces. FIG. 11G depicts an enlarged partial plan view of the mating interface along the line marked “11G” in FIG. 11A. A conductive element may include a curved contact portion 1106 with a contact location on a convex surface. The contact portion 1106 may extend from an intermediate portion of the conductive element and from the insulative portion of the IMLA into an opening 1110. For mating to another connector, the contact portion may press against a mating conductive element. A tip 1108 may extend from the contact portion 1106. As illustrated in FIG. 11G, mated pairs of signal conductive elements of connectors 200 and 700 may have mated ground conductive elements of the connectors on their sides to block energy propagating through the grounds and thus reduce cross talk.

FIGS. 11C-11F illustrate a mating sequence that operates with a tip 1108 that can be shorter than in a conventional connector. In contrast to a connector in which the tip of a mating portion of a conductive element may be retained by a feature in the housing enclosing the conductive element, tip 1108 is free and substantially fully exposed in the opening into which mating conductive element 902 will be inserted. In a conventional connector, such a configuration risks stubbing of the conductive elements as the connectors are mated. However, stubbing of conductive elements 902 and 504 is avoided because each conductive element is moved out of the path of the other conductive element by a feature on a housing around the other conductive element.

The method of operating connectors 200 and 700 may start with bringing the connectors together so that mating conductive elements are aligned, as illustrated in (FIG. 11C). In this state, the conductive element 504 of the right angle connector 200 and conductive elements 902 of the header connector 700 may be in respective rest states, and aligned with one another in a mating direction.

Connectors 200 and 700 may be further pressed together in the mating direction until they reach the state illustrated in FIG. 11D. In this state, conductive element 504 of the right angle connector 200 has engaged with a preload feature 512B of the header connector 700. To reach this state, the angled lead-in portions of 1108 slid along tapered leading edge of preload feature 512B. The preload feature 512B of the header connector 700 deflected the conductive element 504 of the right angle connector 200 from its rest state.

In this example, both connectors have similar mating interface elements, and conductive element 902 of the header connector 700 has similarly engaged with preload feature 512A of the right angle connector 200. The preload feature 512A of the right angle connector 200 deflected the conductive element 902 of the header connector 700 from its rest state. As a result, conductive elements 902 and 504 have been deflected in opposite directions such that the distance between the distal-most portions of their respective tips has increased. Such an increased distance between the tips, moving both tips away from the centerline of the mated conductive elements, reduces that chance that variations in the manufacture or positioning of the connectors during mating will result in the stubbing of conductive elements 902 and 504. Rather, the tapered lead-in portions of conductive elements 902 and 504 will ride along each other as the connectors are pressed together.

Connectors 200 and 700 may be further pressed together in the mating direction until they reach the state illustrated in FIG. 11E. In this state, the conductive element 504 of the right angle connector 200 and conductive elements 902 of the header connector 400 have disconnected from the preload features 512A and 512B, and make contact with each other. Each conductive element is further deflected relative to the state in FIG. 11D when they are engaged with respective preload features 512A or 512B. In this state, the convex contact surface of each conductive element presses against a contact surface, which may be flat, of the mating conductive element.

Connectors 200 and 700 may be further pressed together in the mating direction until they reach the state illustrated in FIG. 11F. In this state, the conductive element 504 of the right angle connector 200 and conductive elements 902 of the header connector 400 may be in a fully-mated condition and make contact with each other at locations 1104A and 1104B. The locations 1104A and 1104B may be at an apex of the convex surface of the contact portions 1106. The configuration may enable a connector to have a smaller wipe length for a contact portion (e.g., contact portion 1106) before reaching a respective contact location (e.g., locations 1104A, 1104B), such as less than 2.5 mm, and may be approximately 1.9 mm, for example.

Each of the conductive elements has an unterminated portion, 1108A and 1108B, respectively, extending beyond its respective contact location 1104A and 1104B. This unterminated portion may form a stub, which can support a resonance. But, as the stub is short, that resonance may be higher than the operating frequency range of the connector, such as above 35 GHz or above 56 GHz. The unterminated portions 1108A and 1108B, may have a length, for example, in the range of 0.02 mm and 2 mm and any suitable value in between, or in the range of 0.1 mm and 1 mm and any suitable value in between, or less than 0.8 mm, or less than 0.5 mm, or less than 0.1 mm.

In some embodiments, as shown in FIGS. 6-10, the shielding members of IMLAs may be connected to respective ground conductors at their mating ends. It should be appreciated from FIGS. 11B and 11F that the connection locations (e.g., where the tabs 952 locate) may overlap with the interface shield 904 of a respective core member, and the beams 954 and slots 958 connecting the tabs 952 to the body 940 may at least partially overlap the interface shield 904 of a respective core member.

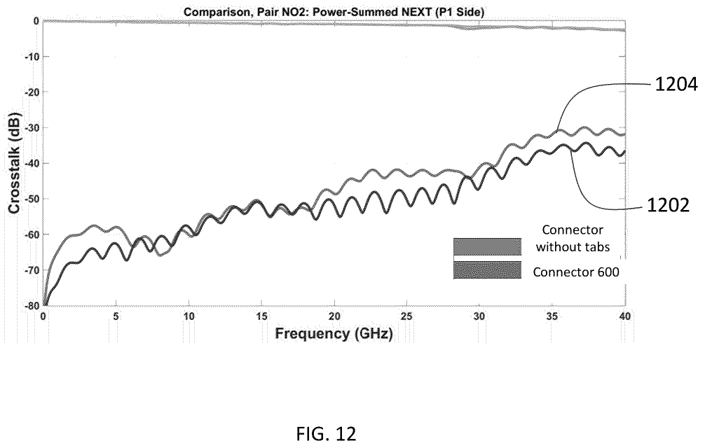

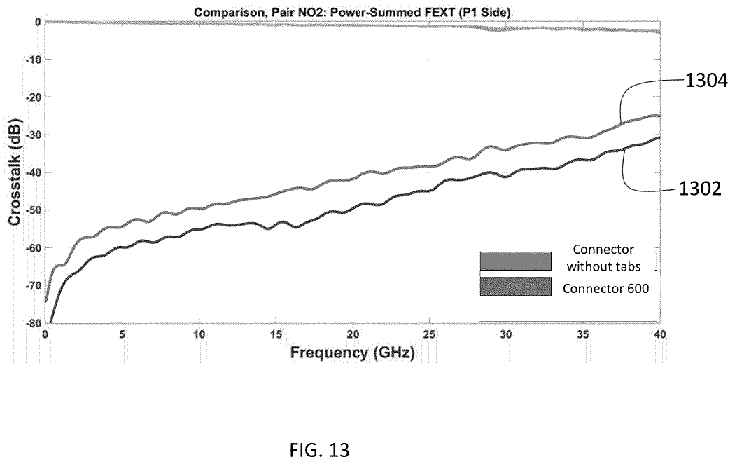

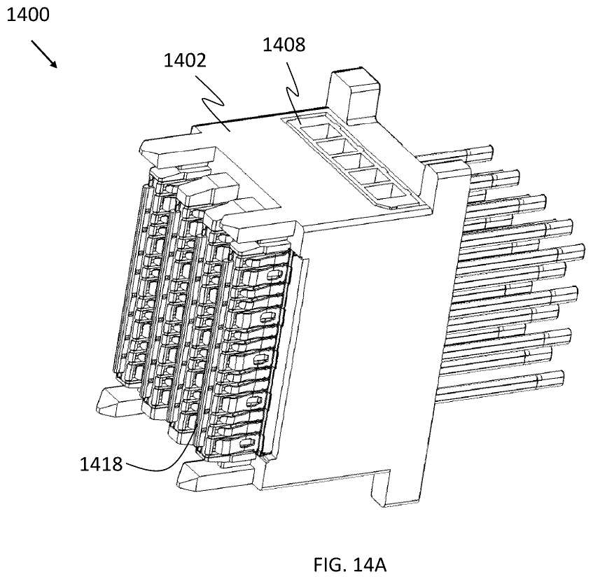

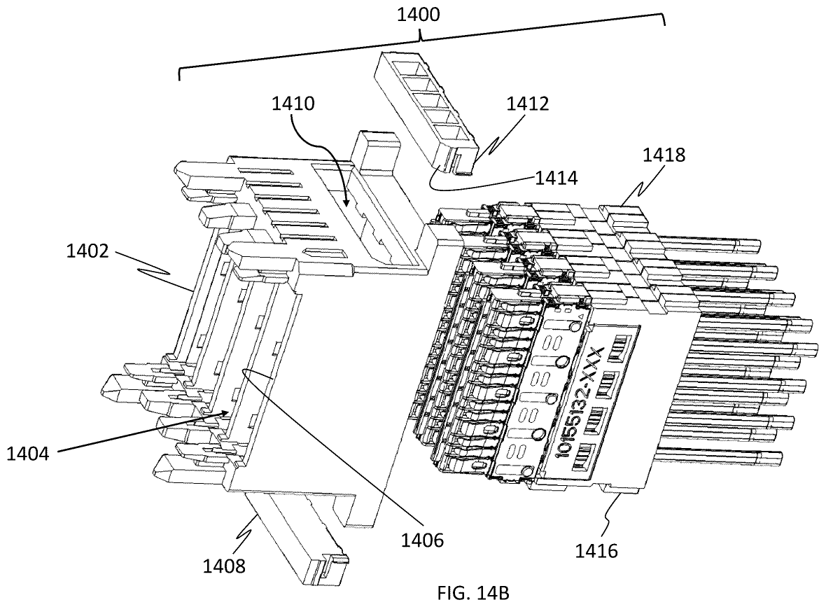

Regardless of the other ground structures within the connector, the inventors have found that connecting shielding members to respective ground conductors adjacent the mating interface, such as is pictured in connection with connector 600, above, surprisingly improves near-end crosstalk (NEXT) and far-end crosstalk (FEXT) over a wide frequency range. FIGS. 12-13 depict simulated NEXT and FEXT, respectively, across a frequency range of the connector 600, compared with a connector without connections between the shielding members and the ground conductors at their mating ends. As illustrated, the connector 600 provides a NEXT curve 1202 and FEXT curve 1302, compared with a NEXT curve 1204 and FEXT curve 1204 of the connector without connections between the shielding members and the ground conductors at their mating ends. The connector 600 significantly reduces both NEXT and FEXT by about 5 dB over a frequency range from 0 to 40 GHz, while other characteristics such as insertion loss and return loss are maintained.

A right-angle connector may mate with connectors in configurations other than a header, such as a cable connector. FIG. 14A and FIG. 14B depict a perspective and partially exploded view of a cable connector 1400 respectively, according to some embodiments. The cable connector 1400 may include dual IMLA cable assemblies 1418 held by a housing 1402. The housing 1402 may include a cavity 1404 surrounded by walls 1406. The cavity 1404 may be configured to hold the dual IMLA cable assemblies 1418. In the illustrated example of FIG. 14B, the dual IMLA cable assemblies 1418 are inserted from the back of the housing 1402 into the cavity 1404. The walls 1406 of the housing 1402 may include features configured to retain the dual IMLA cable assemblies 1418. The retaining features of the walls 1406 may include mating keys, alignment features, and IMLA support features. In some embodiments, the housing 1402 of the cable connector 1400 may be configured with or without internal walls. The dual IMLA cable assemblies 1418 may include overmolds 1416 that separate adjacent dual IMLA cable assemblies 1418.

As with the front housing 300, the housing 1402 may have only or predominately only features that can be easily molded in a mold without moving parts. The housing 1402 may be molded, for example, in a mold that opens and closes in the front to back direction for the housing 1402. Fine features, such as ribs or other features that separate adjacent conductive elements or align with individual conductive elements, and/or features with surfaces and/or corings that extend in a side to side direction, perpendicular to the front to back direction, may be formed as part of assemblies that are inserted into the housing. Those assemblies may include components that are easily molded in a mold that opens and closes in the side to side direction, such as preload features 512.

The housing 1402 may include openings 1410 configured to receive retainers 1408. The retainers 1408 may be configured to securely retain the dual IMLA cable assemblies 1418 in the housing 1402. The retainers 1408 may prevent the dial IMLA cable assemblies 1418 from slipping out of the housing 1402 since the housing 1402, as discussed above, may be molded without fine features perpendicular to the front to back direction. The retainers 1408, which may be molded separately, may include fine features such as chamfers 1414 and crush ribs 1412. The chamfers 1414 may be at selected one or more corners of the retains 1408 such that the retainers 1408 may be assembled into the housing 1402, following the insertions of the dual IMLA cable assemblies 1418, in one orientation but not the opposite direction. The keyed orientation may enable the crush ribs 1412 to bias the retainers 1408 and the dual IMLA cable assemblies 1418 forward towards the mating interface.

Similar to the dual IMLA T-Top assembly 202C of FIG. 5A, a dual IMLA cable assembly may include a Type-A cable IMLA, a Type-B cable IMLA, and a core member therebetween. The core member may have suitable features of any of the core members described herein (e.g., core member 204, core member 606). For example, the core member of a cable IMLA may be configured similar to the T-Top region of the core member of a IMLA for a right-angle connector. The cable IMLAs may have suitable features of the IMLAs (e.g., Type-A IMLA 206A, Type-B IMLA 206B) described herein.

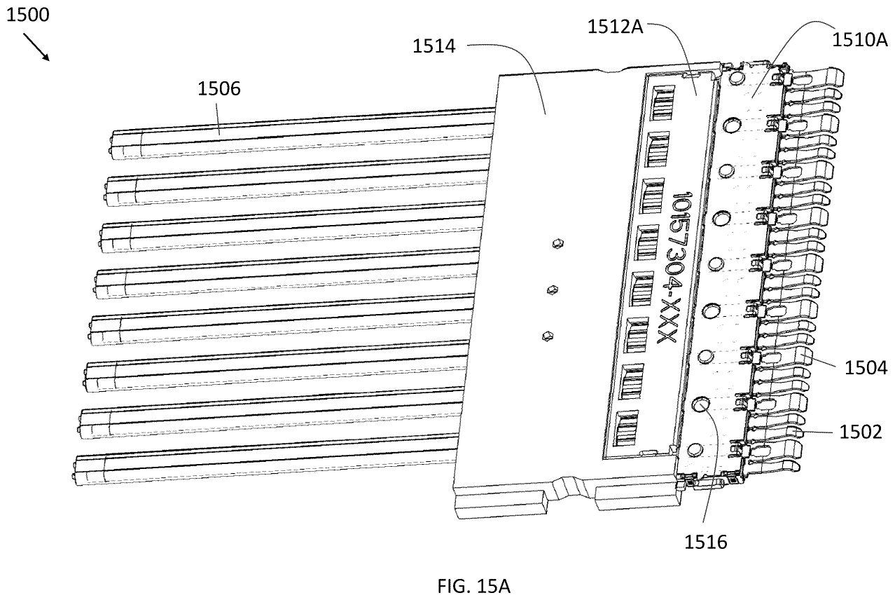

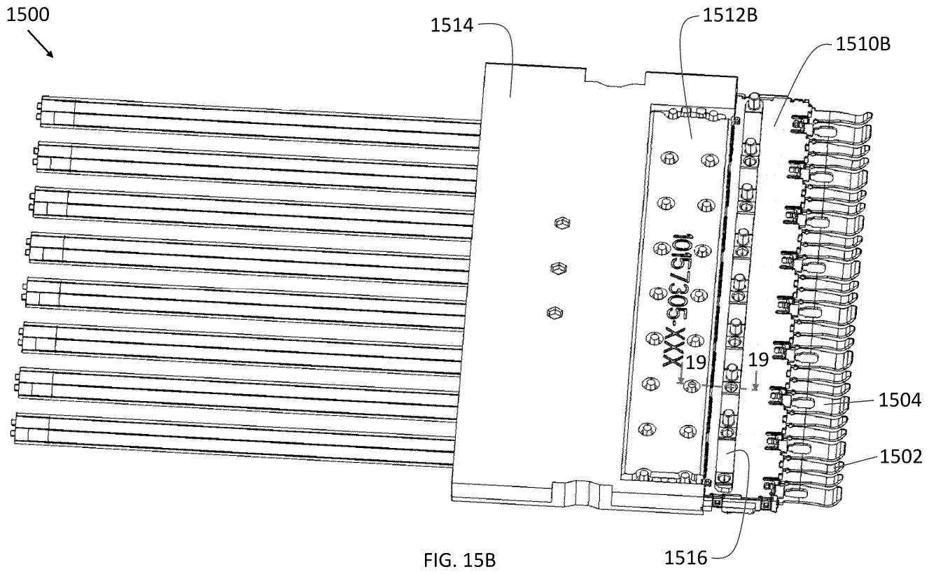

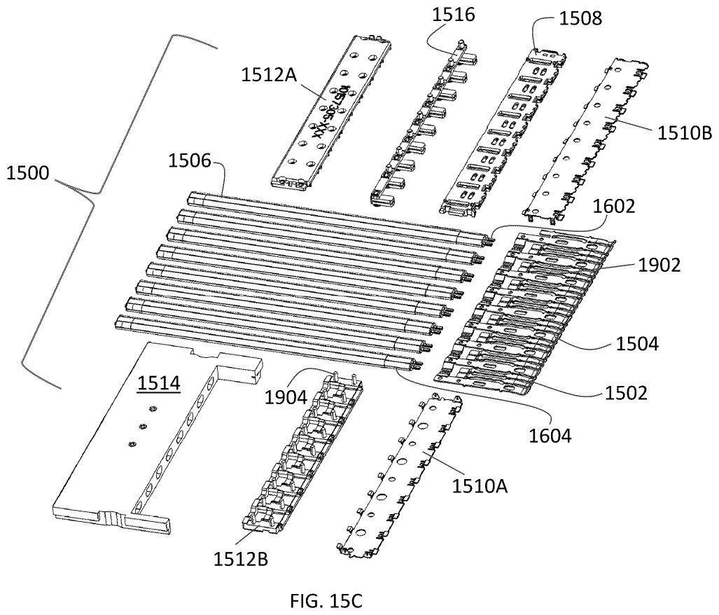

FIG. 15A is a perspective view of a Type-A cable IMLA 1500 that may be in a cable connector like the cable connector 1400, showing a side of the cable IMLA 1500 that faces away from a core member. FIG. 15B is a perspective view of the cable IMLA 1500, showing a side of the cable IMLA that faces towards the core member. FIG. 15C is a partially exploded perspective view of the cable IMLA 1500. The cable IMLA 1500 may include signal conductors 1502 and ground conductors 1504 held by an assembly housing 1508 in a column, and cables 1506 having wires 1602 attached to respective signal conductors 1502 and shields 1604 contacting respective ground conductors 1504. The cable IMLA 1500 may include shielding members 1510A and 1510B disposed on opposite sides of the assembly housing 1508, a lossy member 1516 configured to couple the ground conductors 1504, a conductive hood having portions 1512A and 1512B, and a stress relief overmold 1514. Although a Type-A cable IMLA is illustrated, it should be appreciated that a Type-B cable IMLA may have corresponding features.

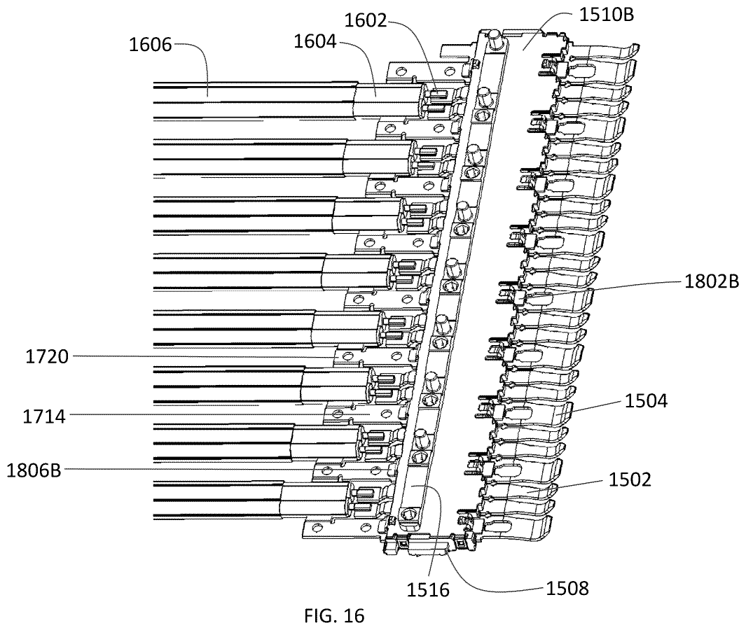

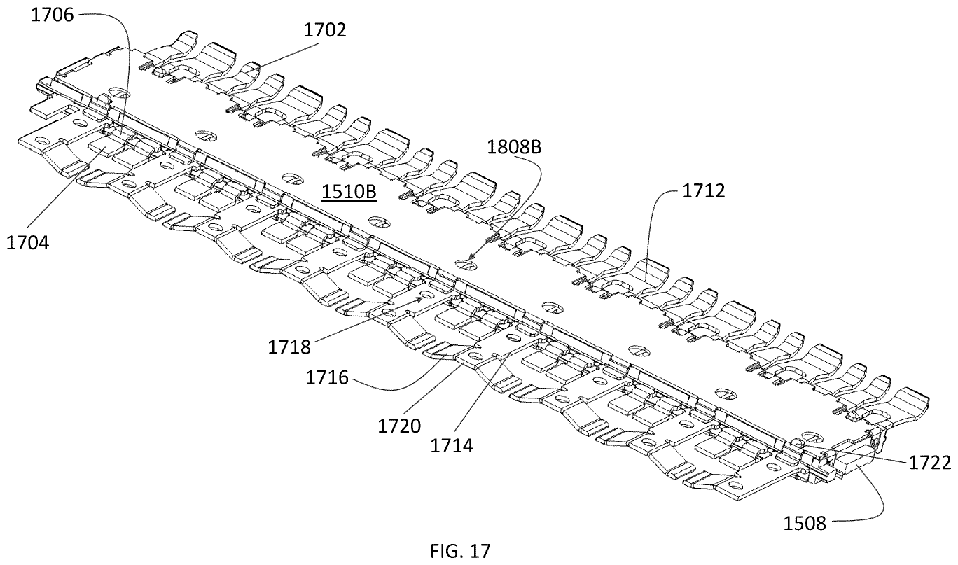

FIG. 16 is a perspective view of the cable IMLA 1500, with the stress relief overmold 1514 and hood portions 1512A, 1512B hidden. FIG. 17 is a perspective view of the cable IMLA 1500, with the lossy member 1516 and cables 1506 hidden. As illustrated, each signal conductor 1502 may include a mating end 1702 extending out of the assembly housing 1508 in a mating direction, a mounting end 1704 opposite the mating end 1702, and an intermediate portion extending between the mating end 1702 and the mounting end 1704. Each signal conductor 1502 may include a jog 1706 such that the mounting end 1704 may be offset from the intermediate portion. Such offset may be configured for accommodating the wires 1602 of the cables 1506.

Each ground conductor 1504 may include a mating end 1712 extending out of the assembly housing 1508 in the mating direction, a mounting end 1714 opposite the mating end 1712, and an intermediate portion extending between the mating end 1712 and the mounting end 1714. The intermediate portion may include an opening 1902 (FIG. 15C). The mounting end 1714 may include a tab 1720, and one or more beams 1716 extending from the tab 1720 and configured to be flexible so as to press against the shields 1640 of the cables 1506. The mounting end 1714 may include one or more openings 1718 that facilitate connection to the hood portions 1512A and 1512B. The conductive hood may hold the mounting ends 1714 of the ground conductors 1504 such that the beams 1716 of the mounting ends 1714 of the ground conductors 1504 may press against the shields of the cables 1506.

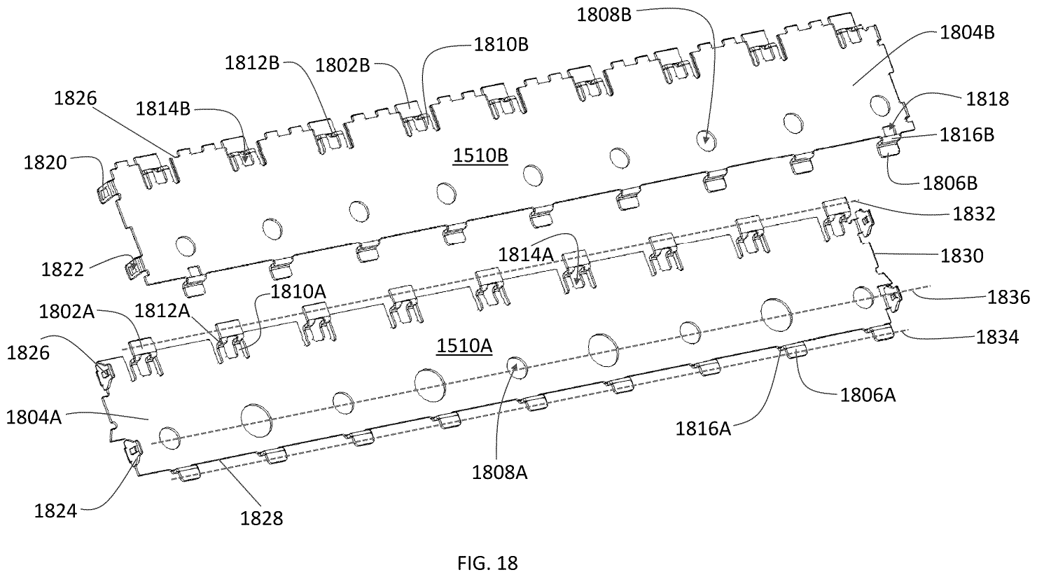

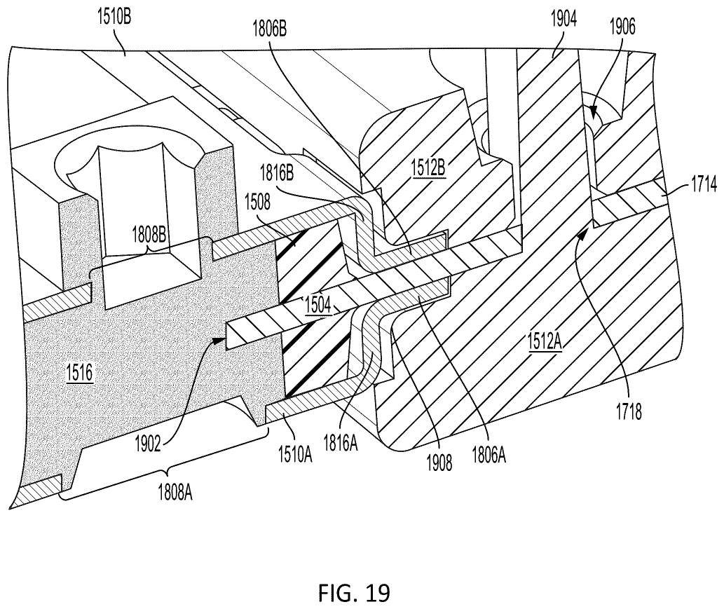

The shielding members 1510A and 1510B may be disposed on opposite sides of the column of signal and ground conductors 1502 and 1504. FIG. 18 is a perspective view of the shielding members 1510A and 1510B. FIG. 19 is a cross-sectional perspective view of a portion of the cable IMLA 1500, along the line marked “19−19” in FIG. 15B. As illustrated, the shielding members 1510A and 1510B may have bodies 1804A and 1804B, respectively. The bodies 1804A and 1804B may be metal plates, extending in respective planes. The bodies 1804A and 1804B may be disposed on opposite sides of the intermediate portions of the column of signal and ground conductors 1502 and 1504.

For each of the shielding members 1510A and 1510B, the body 1804A or 1804B may have a mating side 1826, a mounting side 1828, and sides 1830 connecting the mating side 1826 and the mounting side 1828. The mating ends 1702 and 1712 of the signal and ground conductors 1502 and 1504 may extend beyond the mating side 1826 of respective bodies 1804A and 1804B. The mounting ends 1704 and 1714 of the signal and ground conductors 1502 and 1504 may extend beyond respective mounting side 1828 of the bodies 1804A and 1804B.

The bodies 1804A and 1804B may have openings 1808A and 1808B aligned in respective lines 1836. The openings 1808A of the shielding member 1510A and the openings 1808B of the shielding member 1510B may be disposed in pairs that are aligned in a direction perpendicular to the planes that the bodies 1804A and 1804B extend. The openings 1902 of the intermediate portions of the ground conductors 1504 may be disposed between the openings 1808A and 1808B of respective pairs. As shown in FIG. 19, portions of the lossy member 1516 may extend through the openings 1808A and 1808 Bof the shielding members 1510A and 1510B and the openings 1902 of the ground conductors 1504 so as to couple the intermediate portions of the ground conductors 1504 with the shielding members 1510A and 1510B.

The shielding members 1804A and/or 1804B may have matching locking features with the assembly housing 1508, which may be configured to ensure relative positions between the shielding members 1804A and 1804B and the signal and ground conductors 1502 and 1504. As illustrated, the body 1804B of the shielding member 1510B may have openings 1818 at its mounting side 1828 at opposite ends. The openings 1818 may receive protrusions 1722 of the assembly housing 1508. Although the locking features are illustrated with the shielding member 1804B, it should be appreciated that the shielding member 1804A may have similar locking features in some embodiments and/or the shielding member 1804B may not have such locking features in other embodiments.

The shielding members 1510A and 1510B may have mating tabs 1802A and 1802B extending from the mating side 1826 of respective bodies 1804A and 1804B, and mounting tabs 1806A and 1806B extending from the mounting side 1826 of respective bodies 1804A and 1804B. The shielding members 1510A and 1510B may have side tabs 1820 and 1826 extending from respective sides 1830. The side tabs 1820 and 1826 may have matching protrusions 1824 and openings 1822 such that the side tabs 1820 and 1826 are locked together when the protrusions 1824 of the shielding member 1510A are disposed in the openings 1822 of the shielding member 1510B.

For each of the shielding members 1510A and 1510B, the mating tabs 1802A or 1802B may be aligned in a respective line 1832. The mating tabs 1802A and 1802B may be configured similar to tabs 952 of shielding members 912 and 914 of connector 600. In the illustrated example, the mating tabs 1802A and 1802B may be connected to respective bodies 1804A and 1804B by respective beams 1810A and 1810B and respective transition portions 1812A and 1812B. The beams 1810A and 1810B may be separated by respective slots 1814A and 1814B.

The mounting tabs 1806A and 1806B may be aligned in respective lines 1834, which may be parallel to respective lines 1832. The mounting tabs 1806A and 1806B may be connected to respective bodies 1804A and 1804B by respective transition portions 1816A and 1816B. As illustrated, for the shielding member 1510B, the openings 1818 may be joined to respective mounting tabs 1806B by respective transition portions 1816B.

In some embodiments, for each of the shielding members 1510A and 1510B, the mating tabs 1802A or 1802B and the mounting tabs 1806A or 1806B may extend in a same plane that is parallel to and offset from the plane that the respective body 1804A or 1804B extends. Such a configuration may enable the mating tabs 1802A and 1802B to be disposed on the mating ends 1712 of respective ground conductors 1504, and the mounting tabs 1806A and 1806B to be disposed on the mounting ends 1714 of respective ground conductors 1504.

The hood portions 1512A and 1512B may be conductive. In some embodiments, the hood portions 1512A and 1512B may be formed of die cast metal. As shown in FIG. 19, the hood portion 1512B may include projections 1904 that are inserted into the openings 1718 of the mounting ends 1714 of the ground conductors 1504. The hood portion 1512A may include matching openings 1906 for receiving the projections 1904. The hood portions 1512A and 1512B may include recesses 1908 for accommodating the mounting tabs 1806A and 1806B.

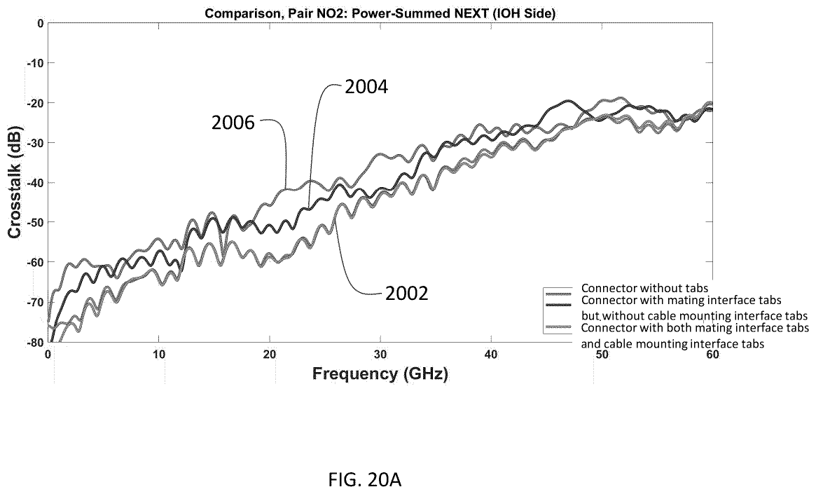

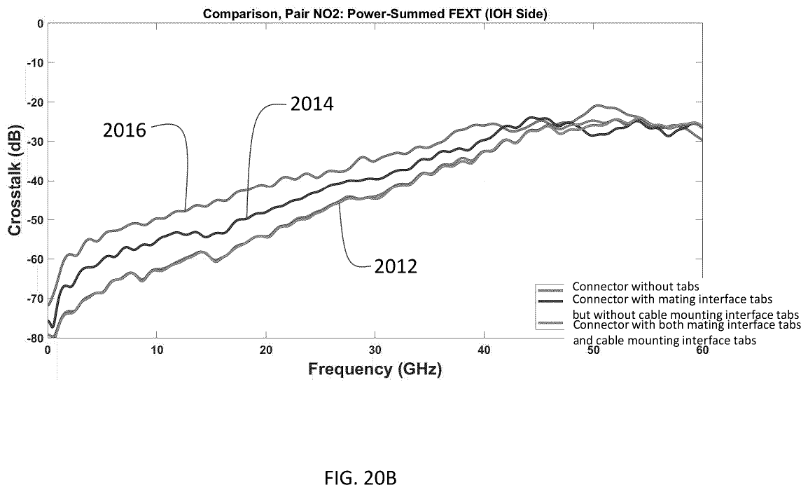

Regardless of the other ground structures within the connector, the inventors have found that connecting shielding members to respective ground conductors adjacent the mounting interface, such as a cable connector with dual IMLA cable assemblies, each of which may have the Type-A cable IMLA 1500 and a corresponding Type-B cable IMLA, surprisingly improves near-end crosstalk (NEXT) and far-end crosstalk (FEXT) over a wide frequency range for both the cable connector and a connector mated with the cable connector. FIGS. 20A-20B depict simulated NEXT and FEXT, respectively, across a frequency range of the cable connector, compared with cable connectors without connections between the shielding members and the ground conductors at their mating ends and/or cable mounting ends, measured when mated with a respective right angle connector (e.g., connector 600).

As illustrated, a first cable connector, which has connections between the shielding members and the ground conductors at both their mating ends and their mounting ends, provides a NEXT curve 2002 and FEXT curve 2012. A second cable connector, which has connections between the shielding members and the ground conductors at their mating ends but not at their mounting ends, provides a NEXT curve 2004 and FEXT curve 2014. A third cable connector, which does not have connections between the shielding members and the ground conductors at either their mating ends or their mounting ends, provides a NEXT curve 2006 and FEXT curve 2016. While the second cable connector reduces NEXT and FEXT over the third cable connector, the first cable connector further reduces both NEXT and FEXT over a frequency range from 0 to 40 GHz over the second cable connector.

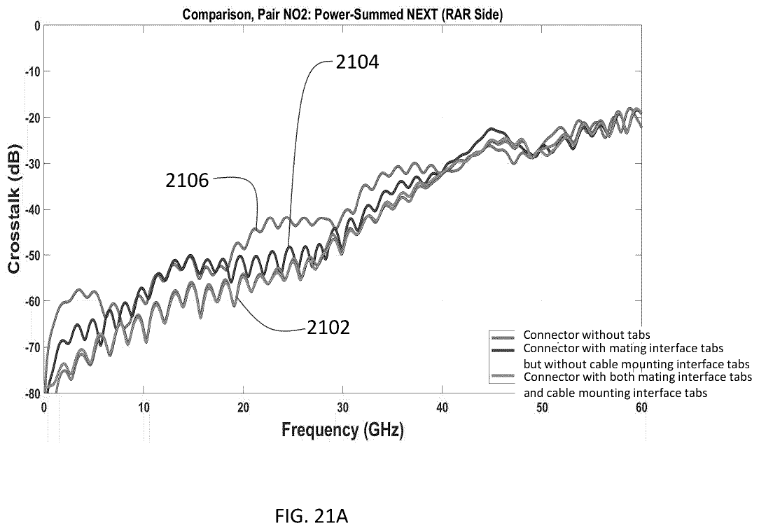

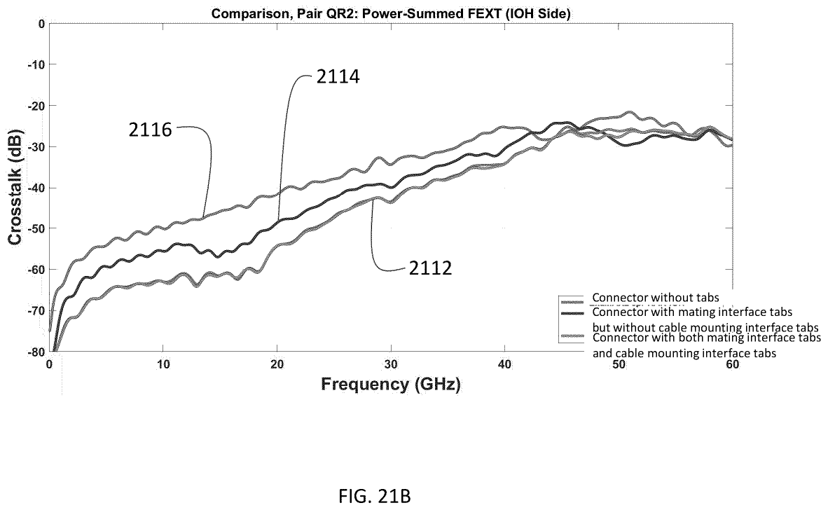

FIGS. 21A-21B depict simulated NEXT and FEXT, respectively, across a frequency range of connector 600, when mated with the first, second, and third cable connectors of FIGS. 20A-20B, respectively. As illustrated, the connector 600 provides a NEXT curve 2102 and FEXT curve 2112 when mated with the first cable connector, a NEXT curve 2104 and FEXT curve 2114 when mated with the second cable connector, and a NEXT curve 2106 and FEXT curve 2116 when mated with the third cable connector. While the connector 600 shows reduced NEXT and FEXT when mated with the second cable connector than when mated with the third cable connector, the connector 600 shows further reduced NEXT and FEXT when mated with the first cable connector than when mated with the second cable connector.

Although details of specific configurations of conductive elements, housings, and shield members are described above, it should be appreciated that such details are provided solely for purposes of illustration, as the concepts disclosed herein are capable of other manners of implementation. In that respect, various connector designs described herein may be used in any suitable combination, as aspects of the present disclosure are not limited to the particular combinations shown in the drawings.

Having thus described several embodiments, it is to be appreciated various alterations, modifications, and improvements may readily occur to those skilled in the art. Such alterations, modifications, and improvements are intended to be within the spirit and scope of the invention. Accordingly, the foregoing description and drawings are by way of example only.

Various changes may be made to the illustrative structures shown and described herein. As a specific example of a possible variation, the connector may be configured for a frequency range of interest, which may depend on the operating parameters of the system in which such a connector is used, but may generally have an upper limit between about 15 GHz and 224 GHz, such as 25 GHz, 30 GHz, 40 GHz, 56 GHz, 112 GHz, or 224 GHz, although higher frequencies or lower frequencies may be of interest in some applications. Some connector designs may have frequency ranges of interest that span only a portion of this range, such as 1 to 10 GHz or 5 to 35 GHz or 56 to 112 GHz.

The operating frequency range for an interconnection system may be determined based on the range of frequencies that can pass through the interconnection with acceptable signal integrity. Signal integrity may be measured in terms of a number of criteria that depend on the application for which an interconnection system is designed. Some of these criteria may relate to the propagation of the signal along a single-ended signal path, a differential signal path, a hollow waveguide, or any other type of signal path. Two examples of such criteria are the attenuation of a signal along a signal path or the reflection of a signal from a signal path.

Other criteria may relate to interaction of multiple distinct signal paths. Such criteria may include, for example, near end cross talk, defined as the portion of a signal injected on one signal path at one end of the interconnection system that is measurable at any other signal path on the same end of the interconnection system. Another such criterion may be far end cross talk, defined as the portion of a signal injected on one signal path at one end of the interconnection system that is measurable at any other signal path on the other end of the interconnection system.

As specific examples, it could be required that signal path attenuation be no more than 3 dB power loss, reflected power ratio be no greater than −20 dB, and individual signal path to signal path crosstalk contributions be no greater than −50 dB. Because these characteristics are frequency dependent, the operating range of an interconnection system is defined as the range of frequencies over which the specified criteria are met.

Designs of an electrical connector are described herein that improve signal integrity for high frequency signals, such as at frequencies to support high data rates in the Gbps range, including up to about 25 Gbps or up to about 40 Gbps, up to about 56 Gbps or up to about 60 Gbps or up to about 75 Gbps or up to about 112 Gbps or higher, while maintaining high density, such as with a spacing between adjacent mating contacts on the order of 3 mm or less, including center-to-center spacing between adjacent contacts in a column of between 1 mm and 2.5 mm or between 2 mm and 2.5 mm, for example. Spacing between columns of mating contact portions may be similar, although there is no requirement that the spacing between all mating contacts in a connector be the same.

Manufacturing techniques may also be varied. For example, embodiments are described in which the daughtercard connector 200 is formed by organizing a plurality of wafers onto a stiffener. It may be possible that an equivalent structure may be formed by inserting a plurality of shield pieces and signal receptacles into a molded housing.

Connector manufacturing techniques were described using specific connector configurations as examples. A header connector, suitable for mounting on a backplane, and a right angle connector, suitable for mounting on a daughter card to plug into the backplane at a right angle, was illustrated for example. The techniques described herein for forming mating and mounting interfaces of connectors are applicable to connectors in other configurations, such as backplane connectors, cable connectors, stacking connectors, mezzanine connectors, I/O connectors, chip sockets, etc.

In some embodiments, contact tails were illustrated as press fit “eye of the needle” compliant sections that are designed to fit within vias of printed circuit boards. However, other configurations may also be used, such as surface mount elements, solderable pins, etc., as aspects of the present disclosure are not limited to the use of any particular mechanism for attaching connectors to printed circuit boards.

The present disclosure is not limited to the details of construction or the arrangements of components set forth in the foregoing description and/or the drawings. Various embodiments are provided solely for purposes of illustration, and the concepts described herein are capable of being practiced or carried out in other ways. Also, the phraseology and terminology used herein are for the purpose of description and should not be regarded as limiting. The use of “including,” “comprising,” “having,” “containing,” or “involving,” and variations thereof herein, is meant to encompass the items listed thereafter (or equivalents thereof) and/or as additional items.

What is claimed is:

1. A lead assembly for an electrical connector, the lead assembly comprising:
an assembly housing;
a plurality of conductive elements held by the assembly housing, each of the plurality of conductive elements comprising a mating end extending out of the assembly housing, a mounting end opposite the mating end and extending out of the assembly housing, and an intermediate portion joining the mating end and the mounting end, the plurality of conductive elements comprising ground conductors disposed between signal conductors; and
a shielding member comprising a body, a plurality of tabs disposed on the mating ends of respective ground conductors of the plurality of conductive elements, and a plurality of transition portions connecting the plurality of tabs to the body.

2. The lead assembly of claim 1, wherein:
tabs of the plurality of tabs of the shielding member are welded to respective ground conductors of the plurality of conductive elements.

3. The lead assembly of claim 1, wherein:
the mounting ends of the plurality of signal conductors are configured for attachment of conductors of respective cables.

4. The lead assembly of claim 1, wherein:
the body of the shielding member comprises a plurality of beams; and
each of the plurality of beams is connected to a respective tab of the plurality of tabs through a transition portion of the plurality of transition portions.

5. The lead assembly of claim 4, wherein:
the body of the shielding member comprises a plurality of slots separating the plurality of beams from each other or an adjacent portion of the body.

6. The lead assembly of claim 1, wherein:
each of the plurality of tabs is connected to the body of the shielding member by two transition portions disposed at opposite ends of the tab.

7. The lead assembly of claim 6, wherein:
each of the two transition portions is connected to a respective beam of the body of the shielding member; and
the respective beams are separated by a slot.

8. The lead assembly of claim 1, wherein:
the assembly housing comprises a first side, a second side opposite the first side, and a mating edge joining the first side and second side;
each of the ground conductors comprises an opening extending therethrough; and
for each of the ground conductors, a respective tab of the plurality of tabs of the shielding member is disposed between the mating edge of the assembly housing and the opening of the ground conductor.

9. The lead assembly of claim 8, wherein:
the mating edge of the assembly comprises a plurality of recesses; and
the plurality of transition portions of the shielding member are disposed in respective recesses of the plurality of recesses.

10. The lead assembly of claim 9, wherein:
the plurality of tabs are at least partially disposed in respective recesses of the plurality of recesses.

11. The lead assembly of claim 1, wherein:
the shielding member is a first shielding member disposed on a first side of the lead assembly; and
the lead assembly comprises a second shielding member comprising a second body disposed on a second side of the lead assembly opposite the first side of the lead assembly, a second plurality of tabs disposed on the mating ends of respective ground conductors of the plurality of conductive elements, and a second plurality of transition portions connecting the second plurality of tabs to the second body.

12. The lead assembly of claim 11, wherein:
tabs of the second plurality of tabs are welded to respective ground conductors of the plurality of conductive elements.

13. The lead assembly of claim 11, wherein:
each of the ground conductors has tabs of the first and second shielding members disposed on opposite sides and overlapping with each other.

14. An electrical connector comprising:
a housing comprising a plurality of walls extending in parallel and bounding a mating interface region; and
a plurality of lead assemblies disposed between the plurality of walls, each of the plurality of lead assemblies comprising:
a column of conductive elements, each comprising a mating end, a mounting end opposite the mating end, and an intermediate portion joining the mating end and the mounting end, and
a shielding member comprising a body extending in a plane parallel to the intermediate portions of the conductive elements of the column, wherein, for each of the plurality of lead assemblies:
the shielding member comprises a plurality of tabs connected to selected ones of the column of conductive elements, and a plurality of beams connected to respective tabs of the plurality of tabs; and
each of the plurality of beams extending into the mating interface region bounded by the plurality of walls.

15. The electrical connector of claim 14, wherein, for each of the plurality of lead assemblies:
the shielding member comprises a plurality of transition portions joining respective beams and tabs; and
the plurality of transition portions extend in a direction perpendicular to the plurality of beams and the column of conductive elements.

16. The electrical connector of claim 14, wherein, for each of the plurality of lead assemblies:
for each tab, the beams connected to the tab are separated from each other by slots extending at least to the respective wall of the plurality of walls.

17. The electrical connector of claim 16, further comprising:
a plurality of core members, each of the plurality of core members comprising a body and a mating portion extending from the body, the body and the mating portion comprising insulative material, the mating portion further comprising an interface shield, wherein:
for each of the plurality of core members, at least one of the plurality of lead assemblies is attached to the core member; and
for each of the plurality of lead assemblies, the slots at least partially overlap the interface shield of the respective core member.

18. The electrical connector of claim 14, further comprising:
a plurality of core members, each of the plurality of core members comprising a body and a mating portion extending from the body, the body and the mating portion comprising insulative material, the mating portion further comprising an interface shield, wherein:
for each of the plurality of core members, at least one of the plurality of lead assemblies is attached to the core member and the shielding members of the at least one of the plurality of lead assemblies is electrically connected to the interface shield.

19. A shielding member for an electrical connector, the shielding member comprising:
a plate comprising a mating side and a mounting side opposite the mating side;
a plurality of first tabs connected to the mating side of the plate and aligned in a first line; and
a plurality of second tabs connected to the mounting side of the plate and aligned in a second line parallel to the first line.

20. The shielding member of claim 19, wherein:
the plate extends in a first plane; and
the plurality of first tabs and the plurality of second tabs extend in a second plane that is parallel to and offset from the first plane.

21. The shielding member of claim 19, wherein:
the plate comprises a plurality of openings aligned in a third line parallel to the first line.

22. The shielding member of claim 19, wherein:
each of the plurality of first tabs is connected to the mating side of the plate via a plurality of compliant beams.

23. The shielding member of claim 19, comprising:
a plurality of first transition portions, wherein:
each of the plurality of first tabs is connected to the mating side of the plate by two of the plurality of first transition portions.

24. The shielding member of claim 23, comprising:
a plurality of second transition portions, wherein:
each of the plurality of second tabs is connected to the mounting side of the plate by a single one of the plurality of second transition portions.

25. The shielding member of claim 24, wherein:
the mounting side of the plate comprises an opening; and
one of the plurality of second transition portions joins the opening of the mounting side of the plate and a second tab at an end of the second line.

26. The shielding member of claim 20, wherein:
the plate comprises a side connecting the mating side and the mounting side;
the shielding member comprises a third tab extending from the side connecting the mating side and the mounting side; and
the third tab extends in a direction perpendicular to the first plane.

27. The shielding member of claim 26, wherein:
the third tab comprises a bulge or an opening configured to receive a bulge.
